(19) United States
(12) Patent Application Publication
(10) Pub. No.: US 2026/0040295 A1
(43) Pub. Date: Feb. 5, 2026

(54) SYSTEM AND METHOD FOR ARCHITECTURE AND DESIGN FOR FAST BEAM MANAGEMENT

(71) Applicant: Huawei Technologies Co., Ltd., Shenzhen (CN)

(72) Inventors: Weimin Xiao, Hoffman Estates, IL (US); Kai Xu, Great Falls, VA (US); Zhigang Rong, San Diego, CA (US); Jialing Liu, Palatine, IL (US)

(21) Appl. No.: 19/299,017

(22) Filed: Aug. 13, 2025

Related U.S. Application Data
(63) Continuation of application No. PCT/US2024/015604, filed on Feb. 13, 2024.
(60) Provisional application No. 63/484,856, filed on Feb. 14, 2023.

(51) Int. Cl. H04W 72/044; H04B 17/318

(52) U.S. Cl. CPC H04W 72/046; H04B 17/328

(57) ABSTRACT

According to embodiments, a network controller transmits one or more radio resource control (RRC) messages to a wireless device, wherein the RRC messages comprise configuration parameters indicating one or more resources for a first uplink signal. The network controller receives, via the one or more resources, the first uplink signal from the wireless device. The network controller derives a first receive beam based on the first uplink signal and transmits the first downlink signal to the wireless device, where the first downlink signal is based on the first receive beam.

### PRIORITY CLAIM AND CROSS-REFERENCE

This patent application is a continuation of International Application No. PCT/US2024/015604, filed on Feb. 13, 2024 and entitled “System and Method for Architecture and Design for Fast Beam Management,” which claims priority to U.S. Provisional Application No. 63/484,856, filed on Feb. 14, 2023 and entitled “System and Method for Architecture and Design for Fast Beam Management,” applications of which are hereby incorporated by reference herein as if reproduced in their entireties.

### TECHNICAL FIELD

The present disclosure relates generally to methods and apparatus for digital communications, and, in particular embodiments, to system and method for architecture and design for fast beam management.

### BACKGROUND

Wireless data traffic has been increasing at a rate of over 50% per year per subscriber, and this trend is expected to accelerate over the next decade with the continual use of video and the rise of the Internet-of-Things (IoTs). To address this demand, the wireless industry is moving to its fifth generation (5G) and beyond cellular technology that will use millimeter wave (mmWave) frequencies, or even higher frequencies, to offer unprecedented spectrum and multi-Gigabit-per-second (Gbps) data rates to a mobile device. To obtain a large amount of new spectrum for wireless communications, mmWave spectrum, for example, frequency range 2 (FR2, from 24.25 GHz to 52.6 GHZ) in 3GPP, was utilized in 5G new radio (NR) system. Another feasible spectrum to be considered is high (or upper) middle band (between 7 GHz to 24 GHz carrier frequency).

A technical problem of millimeter (mm) Wave, upper middle band, or even higher frequencies, for communication is the much higher propagation loss at these frequencies as compared to that of lower frequency bands (e.g., less than 6 GHz). There are higher diffraction and penetration losses which makes reflected and scattered signals more important for communication. Typical penetration losses for building materials vary from a few dBs to more than 40 dBs. There is also absorption by the atmosphere which increases with frequency. On the other hand, as the wavelength of mmWave (or other high frequency band) signals are much shorter, more antenna elements can be packed into a panel of reasonable size which can then be utilized for beamforming to overcome (or compensate/mitigate) for the large propagation loss.

Beamforming can be implemented in two antenna architectures: analog antenna architecture (i.e., analogy beamforming); or digital antenna architecture (i.e., digital beamforming). When the number of antenna elements is large, the all digital antenna architecture has a high cost and consumes a significant amount of power because each antenna element needs to be connected with an individual radio frequency (RF) chain in the all digital antenna architecture. Additionally, each RF chain may include one or more components of: amplifiers, phase shifters, filters, mixers, attenuators, analog-to-digital converters (ADCs)/digital-to-analog converters (DACs), and/or detectors. Therefore, in 5G/NR, analog beamforming with a very limited number of digital chains is used. This analog beamforming method is also referred to as hybrid beamforming, and the corresponding beam management procedure (e.g., through beam sweeping and reporting procedure) is used to obtain and/or maintain proper beamforming (or beam pairs) between the transmitter and the receiver.

### SUMMARY

In accordance with an embodiment, a method performed by a network controller, includes transmitting one or more radio resource control (RRC) messages to a wireless device, wherein the RRC messages comprise configuration parameters indicating one or more resources for a first uplink signal. The method also includes receiving, via the one or more resources, the first uplink signal from the wireless device. The method also includes deriving a first receive beam based on the first uplink signal. The method also includes transmitting, to the wireless device, the first downlink signal based on the first receive beam.

In an embodiment, the receiving the first uplink signal includes receiving the first uplink signal via a digital receive panel. In an embodiment, the digital receive panel is a low resolution (LR) digital receive panel. In an embodiment, the LR digital receive panel comprises an analog-to-digital converter (ADC) with less than a first number of bits. In an embodiment, the first number of bits is one of: 24, 22, 20, 18, 16, 14, 12, 10, 8, 6, 4, or 2. In an embodiment, the method also includes transmitting a second downlink signal to the wireless device based on the transmit beam of the first downlink signal. In an embodiment, the method also includes indicating to the wireless device to receive a first downlink signal based on a transmit beam of the first uplink signal. In an embodiment, the deriving the first receive beam includes deriving the first receive beam based on the first uplink signal via baseband processing. In an embodiment, the transmitting the first downlink signal includes transmitting, to the wireless device, the first downlink signal based on the first receive beam and via an analog/hybrid transmit panel. In an embodiment, the indicating includes indicating to the wireless device to receive the first downlink signal using the transmit beam of the first uplink signal at a first transmission occasion. In an embodiment, the one or more resources include at least one of one or more random access occasions; one or more sounding reference signal resources; or one or more physical uplink control channel resources. In an embodiment, the first uplink signal includes at least one of a preamble, a sounding reference signal, a demodulation reference signal, a scheduling request, a physical uplink control channel, or an uplink control information via physical uplink control channel. In an embodiment, the first downlink signal includes at least one of a physical downlink control channel, a demodulation reference signal, a channel state information reference signal, or a physical downlink data channel. In an embodiment, the indicating includes indicating the first receive beam by indicating an index of the first receive beam. In an embodiment, the index of the first receive beam includes an index of a reference signal. In an embodiment, the wireless device includes a user equipment (UE). In an embodiment, the first uplink signal is a single uplink signal. In an embodiment, the first uplink signal is transmitted by the wireless device using a single transmit beam. In an embodiment, the method also includes receiving, by the network controller, a second uplink signal, based on the first receive beam and via an analog/hybrid receive panel. In an embodiment, the second uplink signal is transmitted by the wireless device, based on the transmit beam of the first uplink signal.

In accordance with an embodiment, a method performed by a wireless device includes receiving one or more radio resource control (RRC) messages from a network controller, wherein the one or more RRC messages include configuration parameters indicating one or more resources for a first downlink signal. The method also includes receiving, from the network controller, the first downlink signal via the one or more resources. The method also includes deriving a first receive beam based on the first downlink signal. The method also includes transmitting to the network controller a first uplink signal using the first receive beam. The method also includes indicating to the network controller, for the network controller to receive the first uplink signal using a transmit beam of the first downlink signal.

In an embodiment, the receiving the first downlink signal includes receiving the first downlink signal based on the transmit beam of the first uplink signal. In an embodiment, the receiving the first downlink signal includes receiving the first downlink signal via a digital receive panel. In an embodiment, the deriving the first receive beam includes deriving the first receive beam based on the first downlink signal via baseband processing. In an embodiment, the transmitting the first uplink signal includes transmitting the first uplink signal to the network controller based on the first receive beam and via an analog/hybrid transmit panel. In an embodiment, the indicating includes indicating, to receive the first uplink signal using the transmit beam of the first downlink signal at a first transmission occasion. In an embodiment, the one or more resources include at least one of one or more channel state information reference signal resources, one or more SSBs, or one or more downlink beam management reference signal resources. In an embodiment, the first downlink signal includes at least one of a channel state information reference signal, a synchronization signal block (SSB), or a downlink beam management reference signal. In an embodiment, the first uplink signal includes at least one of a physical uplink control channel, a demodulation reference signal, a sounding reference signal, a physical uplink data channel, or a physical random access channel preamble. In an embodiment, the indicating includes indicating the first receive beam by indicating an index of the first receive beam. In an embodiment, the index of the first receive beam includes an index of a reference signal. In an embodiment, the wireless device includes a user equipment (UE). In an embodiment, the first downlink signal is a single downlink signal. In an embodiment, the first downlink signal is transmitted by the network controller using a single transmit beam. In an embodiment, the method also includes receiving a second downlink signal based on the first receive beam and via an analog/hybrid receive panel. In an embodiment, the RRC messages indicate a plurality of reference signals (RSS), wherein the first downlink signal includes a first one of the RSs, and wherein the first one of the RSs is determined according to a reference signal received power (RSRP) of the first one of the RSs.

In accordance with an embodiment, a network controller includes at least one processor; and a non-transitory computer readable storage medium storing programming, the programming including instructions that, when executed by the at least one processor, cause the network controller to perform any of the methods described above.

In accordance with an embodiment, a wireless device, includes at least one processor; and a non-transitory computer readable storage medium storing programming, the programming including instructions that, when executed by the at least one processor, cause the wireless device to perform any of the methods described above.

In accordance with an embodiment, a non-transitory computer readable storage medium including instructions that when executed by at least one processor cause the at least one processor to perform any of the methods described above.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example wireless communication system;

FIG. 1B illustrates the use of carrier aggregation (CA);

FIG. 2A illustrates physical layer channels and signals including PSS/SSS, PBCH and its associated DMRS;

FIG. 2B illustrates signals/channels which are multiplexed for more than one UE;

FIG. 2C illustrates examples of non-zero power (NZP) CSI-RS used for channel estimation, interference measurement, and so on, which are multiplexed with PDSCH and for one or more UEs;

FIG. 2D illustrates a resource grid;

FIG. 2E illustrates a diagram of an embodiment digital beamforming;

FIG. 2F illustrates a diagram of an embodiment hybrid beamforming;

FIG. 3 illustrates a diagram of an embodiment beamforming architecture;

FIG. 4 illustrates a diagram of an embodiment beamforming architecture;

FIG. 5 illustrates a diagram of an embodiment procedure for UE side;

FIG. 6 illustrates a diagram of an embodiment procedure for BS side;

FIG. 7 illustrates a diagram of an embodiment procedure for BS side;

FIG. 8 illustrates a diagram of an embodiment procedure for UE side;

FIG. 9 illustrates a diagram of an embodiment operation procedures;

FIG. 10 illustrates a diagram of an embodiment procedure for beam derivation of downlink;

FIG. 11 illustrates a diagram of an embodiment procedure for random access;

FIG. 12 illustrates a diagram of an embodiment procedure for RX beam derivation based on a downlink transmission;

FIG. 13 illustrates a diagram of an embodiment procedure for RX beam derivation based on an uplink transmission;

FIG. 14 illustrates a diagram of an embodiment procedure for beam indication;

FIG. 15 illustrates a diagram of an embodiment procedure for beam indication;

FIG. 16 illustrates a diagram of an embodiment procedure for beam confirmation;

FIG. 17 illustrates an example embodiment communication system;

FIGS. 18A and 18B illustrate example embodiment devices that may implement the methods and teachings according to this disclosure; and

FIG. 19 is a block diagram of an embodiment computing system that may be used for implementing the devices and methods disclosed herein.

### DETAILED DESCRIPTION OF ILLUSTRATIVE EMBODIMENTS

Detailed description and figures of the mixed beamforming communication architecture including possible embodiments/implementations.

To overcome the difficulties and to take advantage the benefits of the analog/hybrid antenna architecture and the all-digital antenna architecture, a new beamforming communication architecture is disclosed, and the corresponding operation procedures for the disclosed antenna architecture are defined. The corresponding operation procedures for the disclosed beamforming communication architecture can be applied for one or more procedures of: obtaining initial beam, (initial) random access, beam derivation for multiple paths, transmission/reception of uplink/downlink/sidelink signals/channels, beam (pair) confirmation, beam failure detection and recovery, and/or the like. In various embodiments, the disclosed beamforming communication architecture includes at least two parts: a digital beamforming antenna array with low-resolution (LR) (e.g., in terms of low number of bits (e.g., being equal to or less than 8 bits) and sampling frequency for ADC) chains (only) used for the receiver; and an analog/hybrid beamforming antenna array with a small number of high-resolution (HR) (e.g., in terms of high number of bits (e.g., being greater than 10 bits) and sampling frequency for ADC) chains for both transmitter and receiver. In an embodiment, antenna elements are shared, for example, via switches to the two beamforming communication architectures. In an embodiment, each of the two beamforming communication architectures includes respective antenna elements, a respective antenna array, or a respective antenna panel. Other alternatives include beamforming communication architecture includes a digital beamforming antenna array with a larger number of digital chains where beamforming is performed largely in digital domain (or baseband) and an analog/hybrid beamforming antenna array with a smaller number of digital chains where beamforming is performed in analog domain (or RF). In an embodiment, UE (or base station) may receive signals/channels based on LR-digital chains and transmit signal/channels based on analog/hybrid beamforming antenna array with a small number of high-resolution (HR) digital chains.

In various embodiments, beam acquisition is performed by user equipment (UE) (or a base station (BS)) using the low-resolution (LR) receiver chains/panel with digital beamforming by receiving signal from the other entity of the communication and deriving the best beam(s) (e.g., with highest reference signal received power (RSRP)) through baseband processing. If beam acquisition is performed by the UE (or the base station), the low-resolution (LR) (e.g., in terms of low number of bits (e.g., being equal to or less than 8 bits) and sampling frequency for ADC) receiver chains/panel can be used, which significantly reduces cost and power consumption for the receiver side (e.g., the UE or the base station). In various disclosed embodiments, beam sweeping procedures are not needed for beam acquisition on the receiver side. This is different from the case of the analog/hybrid antenna array with high-resolution (HR) (e.g., in terms of high number of bits (e.g., being greater than 10 bits) and sampling frequency for ADC) receiver chains in which beam sweeping is needed on the receiver side. Acquired beam(s) are then applied for data/control channel reception and transmission (based on the analog/hybrid array with high-resolution in terms of high number of bits (e.g., being greater than 10 bits) and sampling frequency for ADC) receiver and transmitter chains, for example, assuming beam correspondence being applied. A beam management RS is referred to as a reference signal (RS) including synchronization signal block (SSB), channel state information reference signal (CSI-RS), a physical random access channel (PRACH) preamble, or a sounding reference signal (SRS). Beam acquisition can also be performed for sidelink between 2 UEs and a sidelink reference signal (e.g., sidelink CSI-RS, sidelink SRS, etc.) is used for beam management.

In various embodiments, a UE can acquire beam(s) to access the network, for example, during an initial access (IA) procedure. The UE can obtain coarse time/frequency synchronization and DL beam associated with SSB(s) based on SSBs detection (with the low-resolution (LR) (in terms of low number of bits (e.g., being equal to or less than 8 bits) and sampling frequency for ADC) receiver chain) during IA (or based on CSI-RSs during IA or later stage). During IA, the base station may perform downlink beam sweeping (via SSB(s)) to ensure coverage of initial access (for legacy UEs and/or the enhanced UE). In an embodiment, the base station determines the initial TX beam for beam sweeping (of wide beam width). For example, the base station determines initial TX beam(s) of a beam sweeping order. The base station transmits corresponding initial TX beam(s) according to the beam sweeping order. In an embodiment, the base station determines initial TX beam based on other carrier/band beam information. In an embodiment, the base station determines initial TX beam based on artificial intelligence (AI)/machine learning (ML) algorithm prediction. The UE can derive its RX beam(s) for the corresponding DL beam/SSB (faster without RX beam sweeping based on the low-resolution receiver chain(s) with digital beamforming). The UE can perform primary synchronization signal (PSS)/secondary synchronization signal (SSS) searching, time/frequency (T/F) synchronization and DL beam acquisition, meanwhile with added complexity, RX beam derivation in digital domain with the benefit of faster access of channel.

In various embodiments, the UE may transmit a physical random access channel (PRACH) preamble(s) to a base station based on the obtained receiver beam (utilizing beam correspondence), timing, frequency information, as well as physical broadcast channel (PBCH) message obtained during downlink beam acquirement, time/frequency (T/F) synchronization and detection procedure for PBCH. The UE transmits a PRACH preamble(s) to the base station to help the base station obtain uplink (UL) timing advance (TA) and reception (RX) beam for the base station (BS). The UE may receive one or more radio resource control (RRC) messages (via MIB/SIB during IA) from the base station. The one or more RRC messages indicate an association between PRACH resource(s) (e.g., including preamble(s) and/or PRACH occasion(s)) and SSB(s) (beams), which need more reserved resources for preamble transmissions. The UE can determine a PRACH occasion based on the obtained SSB (or obtained beam) and the association. The UE can transmit the preamble based on the determined PRACH occasion or the obtained SSB. The base station can determine the obtained SSB (or obtained beam) according to the transmitted preamble by the UE via the corresponding PRACH occasion. Alternatively, a common PRACH occasion can be configured and used for the transmission of the PRACH preambles since the BS can derive the RX beam using its low-resolution (LR) receiver chains/panel with digital beamforming done at the baseband. For example, the common PRACH occasion may be a dedicated PRACH occasion configuration for the UE to transmit preamble. The UE may transmit the preamble, via the common PRACH occasion, indicating the acquired beam, for example, by the selected preamble. Based on detection on the common PRACH occasion, the base station can detect the preamble transmitted via the common PRACH occasion and determine the acquired beam by the UE. In an alternative embodiment, the one or more RRC messages indicate one or more SRS resources. The UE may transmit the one or more SRS resources to the base station. The base station can derive the RX beam based on reception of the one or more SRS resources using its low-resolution (LR) receiver chain(s) with digital beamforming. The transmission of the one or more SRS resources can be triggered by the base station via a downlink control information (DCI) or a MAC CE.

In various embodiments, the UE (or base station) can derive multiple beams (and multiple associated delays/Dopplers) for multiple paths of a wireless channel. Each of the multiple derived beams is corresponding to an SRS/PRACH transmission (or beam) via a path of the multiple path channel. Transmit beam(s) for SRS/PRACH transmissions at different time instances (of a same SRS resource, or PRACH occasion/preamble) can be different (and up to UE implementation/derivation in previous steps) and such beam difference information is useful when applying the derived RX team for transmission. When more than one beam is derived, the more than one beam can be used by the UE (or base station) at the same time for transmissions via different panels, especially in the case of MIMO transmission. The processing time to derive RX beam(s) via low-resolution (LR) receiver chains/panel with digital beamforming performed at baseband can be (much) longer than a few OFDM symbols. Such processing time needs to be considered to determine the timing of application of the derived beam(s), and a capability report for the processing time from the UE side is needed. The BS processing time may also need to be provided to the UE (e.g., via RRC messages, Medium Access Control Element (MAC CE), and/or downlink control information (DCI)) for applicable RX beam determination at the UE.

In various embodiments, the Base station can apply the obtained beam(s), determined based on reception of SRS and/or PRACH, for transmissions of PDCCH, PDSCH, and/or CSI-RS. The base station can transmit, to the UE, the DCI and/or the MAC CE indicating the obtained beam(s) for proper reception using the UE's receiver chain(s) with analog beamforming. A downlink transmission using the beam(s) derived at the BS based on an uplink SRS/PRACH transmission can be received at the UE using the TX beam of that SRS/PRACH transmission. Therefore, the indication via DCI and/or MAC CE to the UE includes information of the SRS resource (or PRACH preamble) identification and the transmission instance (e.g., if there is ambiguity on which transmission instance of the SRS resource (or PRACH preamble) was used at the BS to derive the beam). Alternatively, a downlink transmission using a same TX beam of a downlink (DL) RS (SSB, CSI-RS, or other beam management (BM)-RS) transmission based on which of these options the UE used to derive its RX beam previously should be received at the UE using its derived RX beam. The indication via DCI and/or MAC CE to the UE includes information of the DL RS resource identification and the transmission instance (e.g., if there is ambiguity for the transmission instance of the DL RS resource). The transmission instance may be the transmission slot, OFDM symbol(s), radio frame, system frame number (SFN), or the combination of the above. Similarly, UE can apply the obtained beam(s), determined based on DL RS with low-resolution (LR) receiver chain(s) and digital beamforming, for transmissions of PUCCH/PUSCH/SRS. Similar rules can be used to indicate UE TX beam and ensure proper BS RX beam for the receptions of PUCCH/PUSCH/SRS. For the UE to perform RX beam acquisition properly, the UE needs to be aware of the DL RS for its RX beam derivation. The DL RS for RX beam derivation should be a known signal to the UE. Although the LR-digital receiver panel can potentially receive any known RS to derive RX beam by baseband processing, it generally requires high processing complexity, large memory to buffer data of each of the digital chains, and longer latency than receiving with an already derived RX beam. In addition, the derived RX beam also depends on the TX beam of the DL RS. Therefore, it is desirable that the UE is informed by the base station that a DL RS (resource and transmission occasion) is to be used by the UE to derive its RX beam.

In various embodiments, the UE (or the base station) can perform beam (pair) confirmation, and beam failure detection and recovery procedure based on the disclosed beamforming communication architectures. After deriving RX beam using LR-digital receiver chain(s) with digital beamforming, for reception and/or transmission using HR RX/TX chain(s) with analog/hybrid beamforming, a confirmation step is needed to ensure that the derived RX beam is appropriate for reception and transmission of data/control channels because beam determination errors can occur. The sources of errors include signal processing and estimation/detection error (or even failure when the error rate is very high or detection is deemed unreliable) especially in low SINR case, reciprocity (beam correspondence) mis-match between LR receiver chain(s) with digital beamforming and HR transmitter chain(s) with analog/hybrid beamforming, mis-match between LR-digital RX panel and the analog RX panel, mobility/time-varying channel, etc. A derivation/detection success or failure at the UE side needs to be reported to the BS, for example, via positive acknowledgment (ACK) or negative acknowledgment (NACK). Failures happened at the BS can be handled by the BS. Confirmation of a derived BS RX beam can be performed via asking the UE to send an uplink (UL) RS (e.g., which could be the same as the UL RS used to derive BS's RX beam) and by measuring the UL RS using the RX beam via the HR receiver chain(s) with analog/hybrid beamforming. Alternatively, the BS can transmit a DL RS using the derived RX beam and ask the UE to measure and report (e.g., RSRP) using the TX beam of the UL RS used to derive BS's RX beam. Confirmation of a derived UE RX beam can be done in a similar way. In the case that the derived beam is not confirmed, for example, indicated as very low RSRP of the RS measurement, BM RS transmission and beam derivation step may be repeated. After beam derivation and confirmation of derived beam(s), beam failure may occur due to mobility and blockage. Beam failure detection and recovery (BFD and BFR) procedure is needed. With less overhead and faster training, periodic (with relatively short periodicity) and back-and-forth derivation/confirmation between the UE and BS (or between 2 UEs in the case of sidelink) can be performed, and it may not need separate BFD based on the disclosed new beamforming communication architectures. Otherwise, BFD and reporting is needed. BFR can be much faster based on the disclosed procedure using the new beamforming communication architectures.

According to embodiments, one or more radio resource control (RRC) messages are transmitted by a network controller (e.g., a base station) to a wireless device. The one or more RRC messages include configuration parameters. One or more resources for a first downlink signal are indicated by the configuration parameters. The wireless device includes a (low resolution) digital reception panel of digital beamforming and a (high resolution) transmission/reception panel of hybrid/analog beamforming. The first downlink signal is received, based on the (low resolution) digital reception panel and via the one or more resources, by the wireless device from the base station. A first receive beam is derived, based on the first downlink signal and via the (low resolution) digital reception panel by baseband processing, by the wireless device. A first uplink signal is transmitted using the first receive beam by the wireless device to the network controller via the (high resolution) transmission panel of hybrid/analog beamforming. A second downlink signal from the base station is received, based on the first receive beam and via the (high resolution) reception panel of hybrid/analog beamforming, by the wireless device.

In accordance with an embodiment, a method performed by a network controller, includes transmitting one or more radio resource control (RRC) messages to a wireless device, wherein the RRC messages comprise configuration parameters indicating one or more resources for a first uplink signal. The method also includes receiving, via the one or more resources, the first uplink signal from the wireless device. The method also includes deriving a first receive beam based on the first uplink signal. The method also includes transmitting, to the wireless device, the first downlink signal based on the first receive beam.

In an embodiment, the receiving the first uplink signal includes receiving the first uplink signal via a digital receive panel. In an embodiment, the digital receive panel is a low resolution (LR) digital receive panel. In an embodiment, the LR digital receive panel comprises an analog-to-digital converter (ADC) with less than a first number of bits. In an embodiment, the first number of bits is one of: 24, 22, 20, 18, 16, 14, 12, 10, 8, 6, 4, or 2. In an embodiment, the method also includes transmitting a second downlink signal to the wireless device based on the transmit beam of the first downlink signal. In an embodiment, the method also includes indicating to the wireless device to receive a first downlink signal based on a transmit beam of the first uplink signal. In an embodiment, the deriving the first receive beam includes deriving the first receive beam based on the first uplink signal via baseband processing. In an embodiment, the transmitting the first downlink signal includes transmitting, to the wireless device, the first downlink signal based on the first receive beam and via an analog/hybrid transmit panel. In an embodiment, the indicating includes indicating to the wireless device to receive the first downlink signal using the transmit beam of the first uplink signal at a first transmission occasion. In an embodiment, the one or more resources include at least one of one or more random access occasions; one or more sounding reference signal resources; or one or more physical uplink control channel resources. In an embodiment, the first uplink signal includes at least one of a preamble, a sounding reference signal, a demodulation reference signal, a scheduling request, a physical uplink control channel, or an uplink control information via physical uplink control channel. In an embodiment, the first downlink signal includes at least one of a physical downlink control channel, a demodulation reference signal, a channel state information reference signal, or a physical downlink data channel. In an embodiment, the indicating includes indicating the first receive beam by indicating an index of the first receive beam. In an embodiment, the index of the first receive beam includes an index of a reference signal. In an embodiment, the wireless device includes a user equipment (UE). In an embodiment, the first uplink signal is a single uplink signal. In an embodiment, the first uplink signal is transmitted by the wireless device using a single transmit beam. In an embodiment, the method also includes receiving, by the network controller, a second uplink signal, based on the first receive beam and via an analog/hybrid receive panel. In an embodiment, the second uplink signal is transmitted by the wireless device, based on the transmit beam of the first uplink signal.

In accordance with an embodiment, a method performed by a wireless device includes receiving one or more radio resource control (RRC) messages from a network controller, wherein the one or more RRC messages include configuration parameters indicating one or more resources for a first downlink signal. The method also includes receiving, from the network controller, the first downlink signal via the one or more resources. The method also includes deriving a first receive beam based on the first downlink signal. The method also includes transmitting to the network controller a first uplink signal using the first receive beam. The method also includes indicating to the network controller, for the network controller to receive the first uplink signal using a transmit beam of the first downlink signal.

In an embodiment, the receiving the first downlink signal includes receiving the first downlink signal based on the transmit beam of the first uplink signal. In an embodiment, the receiving the first downlink signal includes receiving the first downlink signal via a digital receive panel. In an embodiment, the deriving the first receive beam includes deriving the first receive beam based on the first downlink signal via baseband processing. In an embodiment, the transmitting the first uplink signal includes transmitting the first uplink signal to the network controller based on the first receive beam and via an analog/hybrid transmit panel. In an embodiment, the indicating includes indicating, to receive the first uplink signal using the transmit beam of the first downlink signal at a first transmission occasion. In an embodiment, the one or more resources include at least one of one or more channel state information reference signal resources, one or more SSBs, or one or more downlink beam management reference signal resources. In an embodiment, the first downlink signal includes at least one of a channel state information reference signal, a synchronization signal block (SSB), or a downlink beam management reference signal. In an embodiment, the first uplink signal includes at least one of a physical uplink control channel, a demodulation reference signal, a sounding reference signal, a physical uplink data channel, or a physical random access channel preamble. In an embodiment, the indicating includes indicating the first receive beam by indicating an index of the first receive beam. In an embodiment, the index of the first receive beam includes an index of a reference signal. In an embodiment, the wireless device includes a user equipment (UE). In an embodiment, the first downlink signal is a single downlink signal. In an embodiment, the first downlink signal is transmitted by the network controller using a single transmit beam. In an embodiment, the method also includes receiving a second downlink signal based on the first receive beam and via an analog/hybrid receive panel. In an embodiment, the RRC messages indicate a plurality of reference signals (RSS), wherein the first downlink signal includes a first one of the RSs, and wherein the first one of the RSs is determined according to a reference signal received power (RSRP) of the first one of the RSs.

In accordance with an embodiment, a network controller includes at least one processor; and a non-transitory computer readable storage medium storing programming, the programming including instructions that, when executed by the at least one processor, cause the network controller to perform any of the methods described above.

In accordance with an embodiment, a wireless device, includes at least one processor; and a non-transitory computer readable storage medium storing programming, the programming including instructions that, when executed by the at least one processor, cause the wireless device to perform any of the methods described above.

In accordance with an embodiment, a non-transitory computer readable storage medium including instructions that when executed by at least one processor cause the at least one processor to perform any of the methods described above.

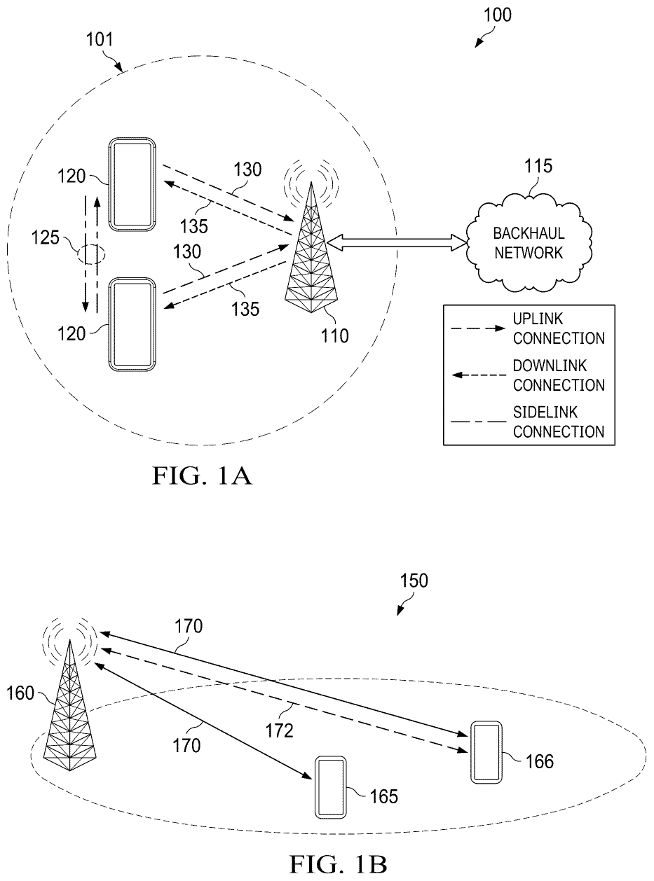

FIG. 1A illustrates an example wireless communication system 100. Communication system 100 includes a base station 110 with coverage area 101. The base station 110 serves a plurality of user equipment (UEs), including UEs 120. Transmissions from the base station 110 to a UE is referred to as a downlink (DL) transmission and occurs over a downlink channel (shown in FIG. 1A as a solid arrowed line 135), while transmissions from a UE to the base station 110 is referred to as an uplink (UL) transmission and occurs over an uplink channel (shown in FIG. 1A as a dashed arrowed line 130). Data carried over the uplink/downlink connections may include data communicated between the UEs 120, as well as data communicated to/from a remote-end (not shown) by way of a backhaul network 115. Example uplink channels and signals include physical uplink shared channel (PUSCH), physical uplink control channel (PUCCH), an uplink sounding reference signal (SRS), or physical random access channel (PRACH). Services may be provided to the plurality of UEs by service providers connected to the base station 110 through the backhaul network 115, such as the Internet. The wireless communication system 100 may include multiple distributed access nodes 110.

In a typical communication system, there are several operating modes. In a cellular operating mode, communications to and from the plurality of UEs go through the base station 110, while in device to device communications mode, such as proximity services (ProSe) operating mode, for example, direct communication between UEs is possible. As used herein, the term “base station” refers to any component (or collection of components) configured to provide wireless access to a network. Base stations may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, access nodes, access points (APs), transmission points (TPs), transmission-reception points (TRPs), cells, carriers, macro cells, femtocells, pico cells, relays, customer premises equipment (CPE), the network side, the network, and so on. In the present disclosure, the terms “base station” and “TRP” are used interchangeably unless otherwise specified. As used herein, the term “UE” refers to any component (or collection of components) capable of establishing a wireless connection with a base station. UEs may also be commonly referred to as mobile stations, mobile devices, mobiles, terminals, user terminals, users, subscribers, stations, communication devices, CPEs, relays, Integrated Access and Backhaul (IAB) relays, and the like. It is noted that when relaying is used (based on relays, picos, CPEs, and so on), especially multi-hop relaying, the boundary between a controller and a node controlled by the controller may become blurry, and a dual node (e.g., either the controller or the node controlled by the controller) deployment where a first node that provides configuration or control information to a second node is considered to be the controller. Likewise, the concept of UL and DL transmissions can be extended as well.

A cell may include one or more bandwidth parts (BWPs) for UL or DL allocated for a UE. Each BWP may have its own BWP-specific numerology and configuration, such as the BWP's bandwidth. It is noted that not all BWPs need to be active at the same time for the UE. A cell may correspond to one carrier, and in some cases, multiple carriers. Typically, one cell (a primary cell (PCell) or a secondary cell (SCell), for example) is a component carrier (a primary component carrier (PCC) or a secondary CC (SCC), for example). For some cells, each cell may include multiple carriers in UL, one carrier may be referred to as an UL carrier or non-supplementary UL (non-SUL, or simply UL) carrier which has an associated DL, and other carriers are called supplementary UL (SUL) carriers which do not have an associated DL. A cell, or a carrier, may be configured with slot or subframe formats including DL and UL symbols, and that cell or carrier may be seen as operating in a time division duplexed (TDD) mode. In general, for unpaired spectrum, the cells or carriers are in TDD mode, and for paired spectrum, the cells or carrier are in a frequency division duplexed (FDD) mode. A transmission time interval (TTI) generally corresponds to a subframe (in LTE) or a slot (in NR). Access nodes may provide wireless access in accordance with one or more wireless communication protocols, e.g., long term evolution (LTE), LTE advanced (LTE-A), 5G, 5G LTE, 5G NR, future 5G NR releases, 6G, High Speed Packet Access (HSPA), Wi-Fi 802.11a/b/g/n/ac, etc. While it is understood that communication systems may employ multiple access nodes (or base stations) capable of communicating with a number of UEs, only one access node, and two UEs are illustrated in FIG. 1A for simplicity.

A way to increase the network resources is to utilize more usable spectrum resources, which include not only the licensed spectrum resources of the same type as the macro, but also the licensed spectrum resources of different type as the macro (e.g., the macro is an FDD cell but a small cell may use both FDD and TDD carriers), as well as unlicensed spectrum resources and shared-licensed spectrums. Some of the spectrum resources lie in high-frequency bands, such as 6 GHz to 60 GHz. The unlicensed spectrums may be used by generally any user, subject to regulatory requirements. The shared-licensed spectrums are also not exclusive for an operator to use. Traditionally, the unlicensed spectrums are not used by cellular networks because it is generally difficult to ensure quality of service (QoS) requirements. Operating on the unlicensed spectrums mainly includes wireless local area networks (WLAN), e.g., the Wi-Fi networks. Due to the fact that the licensed spectrum is generally scarce and expensive, utilizing the unlicensed spectrum by the cellular operator may be considered. Note that on high-frequency bands and unlicensed/shared-licensed bands, typically TDD is used and hence the channel reciprocity can be exploited for the communications.

In an embodiment deployment, a gNB may control one or more cells. Multiple remote radio units may be connected to the same base band unit of the gNB by fiber cable, and the latency between base band unit and remote radio unit is quite small. Therefore, the same base band unit can process the coordinated transmission/reception of multiple cells. For example, the gNB may coordinate the transmissions of multiple cells to a UE, which is called coordinated multiple point (CoMP) or multi-TRP (mTRP, M-TRP) transmission. The gNB may also coordinate the reception of multiple cells from a UE, which is called CoMP/M-TRP reception. In this case, the backhaul link between these cells with the same gNB is fast backhaul and the scheduling of data transmitted in different cells for the UE can be easily coordinated in the same gNB. The backhaul connections may also be ones with longer latency and lower transmission rates.

FIG. 1B illustrates the use of carrier aggregation (CA), which is another deployment strategy. As shown in FIG. 1B, system 150 is a typical wireless network configured with carrier aggregation (CA) where communications controller 160 communicates to wireless device 165 using wireless link 170 (solid line) and to wireless device 166 using wireless link 172 (dashed line) and using wireless link 170, respectively. In some example deployments, for wireless device 166, wireless link 170 can be called a primary component carrier (PCC) while wireless link 172 can be called a secondary component carrier (SCC). In some carrier aggregation deployments, the PCC can carry feedback from a UE device to a communications controller while the SCC can only carry data traffic. In the 3GPP specifications, a component carrier is called a cell. When multiple cells are controlled by a same eNB, cross scheduling of multiple cells can be implemented because there may be a single scheduler in the same eNB to schedule the multiple cells. With CA, one eNB may operate and control several component carriers forming primary cell (PCell) and secondary cell (SCell).

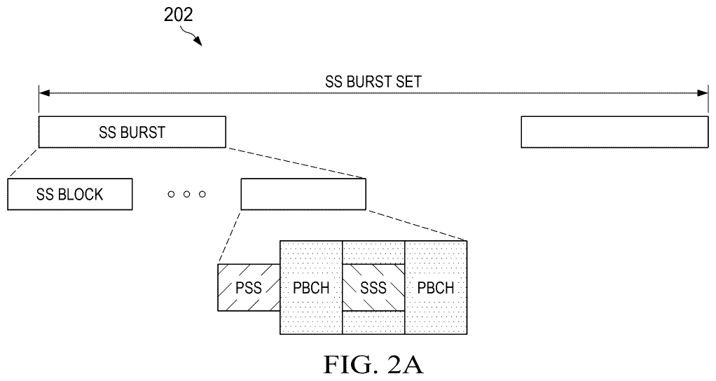

Physical layer channels and signals include PSS/SSS, PBCH and its associated DMRS (see, e.g., FIG. 2A which is a diagram 202 illustrating physical layer channels and signals include PSS/SSS, PBCH and its associated DMRS, in which the SS bursts are embedded, i.e., multiplexed with PBCH around it), PDSCH and its associated DMRS and phase tracking reference signal (PT-RS), PDCCH and its associated DMRS (see, e.g., FIG. 2B, which is a diagram 204 that illustrates signals/channels which are multiplexed for more than one UE, for some of these signals/channels which are multiplexed for more than one UE), and CSI-RS which further include those used, for CSI acquisition, for beam management, and for tracking (see FIG. 2C, which is a diagram 206 that illustrates examples of non-zero power (NZP) CSI-RS used for channel estimation, interference measurement, and so on, which are multiplexed with PDSCH and for one or more UEs, for some examples of non-zero power (NZP) CSI-RS used for channel estimation, beam management, interference measurement, and so on, which are multiplexed with PDSCH and for one or more UEs). The CSI-RS for tracking is also called a tracking reference signal (TRS).

FIG. 2D illustrates a resource grid 208 based on OFDM for DL (similar resource grid exists for UL). Each resource unit in the resource grid is uniquely identified by (r, k, l). The first index r is an index in the spatial domain such as the antenna port, ranging from 1 to R (or 0 to R−1). The second index k is an index in the frequency domain for the subcarrier, ranging from 0 to

$$K = {N}_{RB}^{DL} {N}_{SC}^{RB} - 1 , where {N}_{SC}^{RB} = 12 ,$$

that is, 12 subcarrier form the frequency resource for a resource block (RB), and there can be

$${N}_{RB}^{DL}$$

configured for a BWP or a carrier. The third index l is in the time domain for the OFDM symbol, ranging from 0 to

$$L = {N}_{symb}^{DL} - 1 ,$$

where 14 OFDM symbols form a slot, and a number of slots form a radio frame. A subcarrier and an OFDM symbol determine a resource element (RE). The numerologies can depend on the subcarrier spacing index μ and the values for some resource grids are shown in below tables. Though this figure and tables are primarily for OFDM based designs, the embodiments in this disclosure can apply to not only OFDM based designs but also other waveform based designs.

TABLE 1
Number of OFDM symbols per slot, slots per frame, and
slots per subframe for normal cyclic prefix.

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

TABLE 2
Number of OFDM symbols per slot, slots per frame, and slots per
subframe for extended cyclic prefix.

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

Beamforming can be implemented in two different architectures, including analog antenna architecture (i.e., analogy or RF beamforming), or digital antenna architecture (i.e., digital or baseband beamforming). With large number of antenna elements, all digital antenna architecture, as shown in FIG. 1, is being with high cost and consumes significant amount of power because each antenna port from baseband (BB) needs to be connected with an individual radio frequency (RF) chain (or transmission unit (TXU)) in all digital antenna architecture and further connected with radio distribution network (RDN) and adaptive antenna (AA) elements. Additionally, each RF chain may include one or more components of: amplifiers, phase shifter, filters, mixers, attenuators, analog-to-digital converter (ADC)/digital-to-analog converter (DAC), and/or detectors. Its advantages include potentially good performance in terms of short beam acquisition time, low overhead, and high throughput and coverage. Note that for transmission side, all digital chain does not help TX beam training. Its benefits for TX beamforming include enabling sub-band beamforming comparing to wideband only beamforming of analog beamforming, and very high order MU (multi-user)/multi-beam transmission for SU/MU-MIMO. Its disadvantages, mainly due to digital chain per each (or each subset of a small number of) antenna elements, include high complexity/cost and very high power-consumption which render it commercially infeasible. FIG. 2F illustrates a diagram 210 of an embodiment hybrid beamforming. Therefore, in 5G/NR frequency range 2 (FR2), analog beamforming with very limited number of digital chains is used, which is also called hybrid beamforming, as shown in FIG. 2F, and the corresponding beam management procedure (e.g., through beam sweeping and reporting procedure) is used to obtain and/or maintain proper beamforming (or beam pairs) between the transmitter and the receiver.

However, the beam management procedure in 5G/NR through beam sweeping and reporting procedure significantly increases latency, power consumption and complexity of receiver side (e.g., UE or base station) because of the beam sweeping and reporting at receiver side. Long latency of beam sweeping and reporting inevitably causes frequent beam failure and communication interruption even in a moderate mobility situation. Additionally, if considering much more high frequencies (e.g., mmWave and higher frequencies) will be used in future releases including 5G and beyond (for example 6G) and the beams become much narrower than before in those frequencies, the legacy beam management mechanism based on beam sweeping and reporting (both at transmitter side and at receiver side) inevitably impacts practical deployments of multiple input and multiple output (MIMO) system and further damages the potential of the MIMO system. Therefore, there is a need to improve the efficiency and performance and reduce latency of beam management procedure without significantly increasing the power consumption and complexity of the MIMO system. To that end, a new beamforming communication architecture is disclosed, and the corresponding operation procedures for the disclosed antenna architecture are also defined and disclosed.

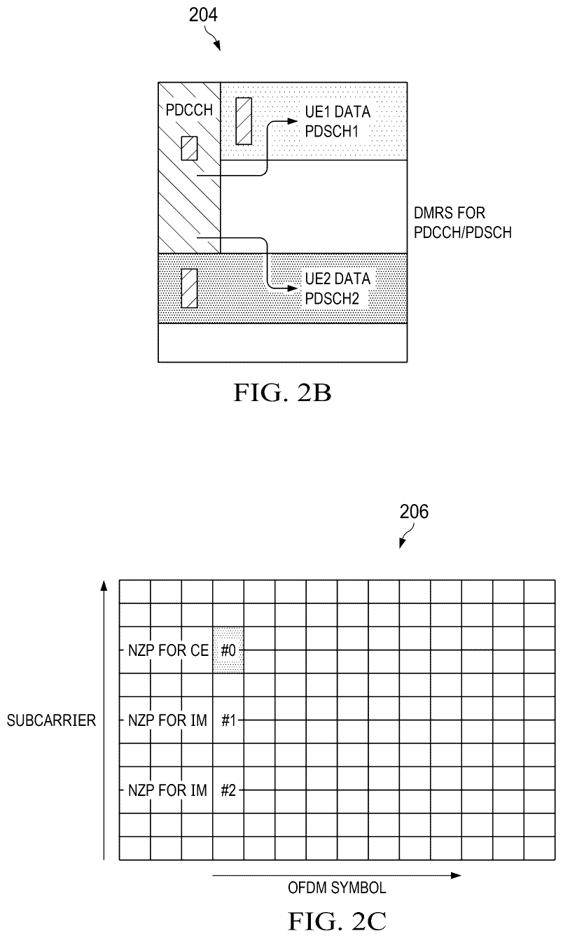

FIG. 3 illustrates a diagram of an embodiment beamforming communication architecture 300. The disclosed beamforming architecture 300 includes at least two parts: the first part is a digital antenna array 302 with a large (or larger) number of low-resolution (LR) (e.g., in terms of low number of bits (e.g., being equal to or less than 8 bits) and sampling frequency for ADC) digital RX panels 312, 314, which can be (only) used for the receiver; and the second part is an analog/hybrid antenna array 306 with a small (or smaller) number of high-resolution (HR) (e.g., in terms of high number of bits (e.g., being greater than 10 bits) and sampling frequency for ADC) digital RX panels 316, 318, which can be used for both transmitter and receiver. The antenna elements 310 are shared, for example, via switches 302 to the two beamforming architectures (i.e., the first part 304 and the second part 306). In an embodiment, the number of the antenna elements 310 used for the first part 304 may be less than the number antenna elements 310 used for the second part 306. In an embodiment, the number of the antenna elements 310 used for the first part 304 may be equal to the number antenna elements used for the second part 306.

FIG. 2E illustrates a diagram 210 of an embodiment digital beamforming. Each chain of RDN+AA 232, as shown in FIG. 2E, used for the first part (i.e., digital beamforming array with LR digital RX panels) is connected to a respective LR digital RX panel 224, 226, 228, 230, for example, which includes one or more of: an amplifier, a phase shifter, mixers, ADC, etc. Two or more of chains of RDN+AA 266 for beamforming 262, 264, as shown in FIG. 2F, used for the second part (analog/hybrid antenna array with a small number of HR digital RX panels) are connected to a respective HR digital RX panel 258, 260, for example, which includes one or more of: an amplifier, a phase shifter, mixers, ADC, etc. Two or more of antenna elements used for the second part (analog/hybrid antenna array with a small number of HR digital chains) are connected to a respective HR digital chain, for example, which includes one or more of: an amplifier, a phase shifter, mixers, ADC, etc. The amplifier, phase shifter, or mixer in HR digital RX panel may have more efficient performance and/or more cost than the amplifier, phase shifter, or mixer in LR digital RX panel. The ADC in HR digital RX panel has more efficient performance, more cost, more number of bits, and/or higher sampling frequency than the ADC in LR digital RX panel. For example, the ADC in HR digital RX panel may have more than 10 bits. The ADC in LR digital RX panel may have less than 8 bits. In an embodiment, the first part and the second part can be used by UE (or base station) at the same time. In an embodiment, the first part and the second part can be used by UE (or base station) at different time.

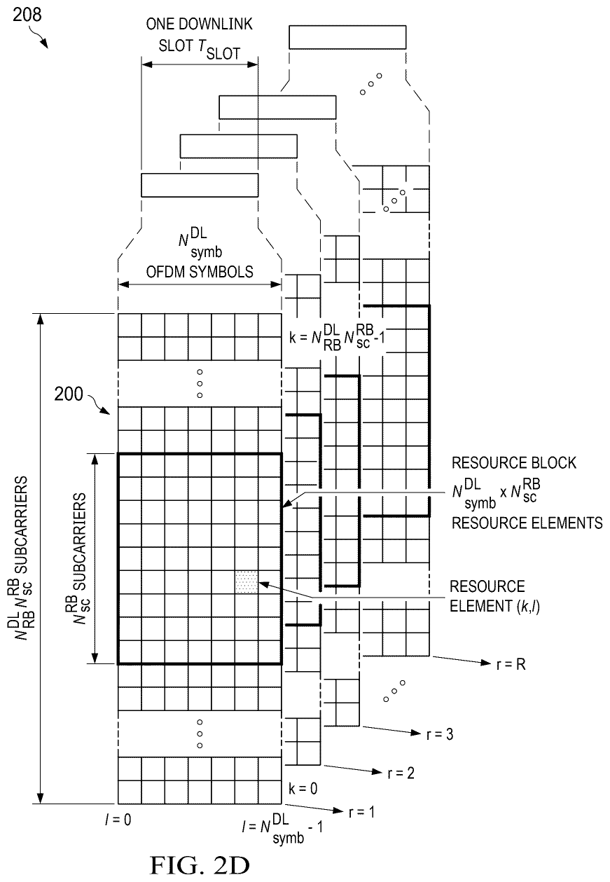

In an embodiment, each of the two beamforming architectures is connected to respective antenna elements (or a respective antenna array or a respective antenna panel). FIG. 4 illustrates a diagram of an embodiment beamforming architecture 400 for the embodiment. The disclosed beamforming architecture 400 includes at least two parts: the first part 408 is a digital antenna array with a large (or larger) number of low-resolution (LR) (e.g., in terms of low number of bits (e.g., being equal to or less than 8 bits) and sampling frequency for ADC) digital RX panel 412, 414, which can be (only) used for the receiver; and the second part 410 is an analog/hybrid antenna array with a small (or smaller) number of high-resolution (HR) (e.g., in terms of high number of bits (e.g., being greater than 10 bits) and sampling frequency for ADC) digital RX panels 416, 418, which can be used for both transmitter and receiver. Each of the two parts 408, 410 is connected to a respective antenna array 404, 406 with multiple antenna elements. For example, the first part 408 is connected to a first antenna panel 404. The second part 410 is connected to a second antenna panel 406. In an embodiment, the number of the antenna elements used for the first part 408 (or the first antenna panel 404) may be less than the number antenna elements used for the second part 410 (or the second antenna panel 406). In an embodiment, the number of the antenna elements used for the first part 408 (or the first antenna panel 404) may be equal to the number antenna elements used for the second part 410 (or the second antenna panel 406).

Each of RDN+AA 402 of the first antenna panel 404 used for the first part 408 (i.e., digital antenna array with LR RF chains 422, 424) is connected to a respective LR RF chain 422, 424, for example, which includes one or more of: an amplifier, a phase shifter, mixers, ADC, etc. Two or more of antenna elements of the second antenna panel 406 used for the second part 410 (analog/hybrid antenna array with a small number of HR RF chains 426, 428) are connected to a respective HR RF chain 426, 428, for example, which includes one or more of: an amplifier, a phase shifter, mixers, ADC, etc. The amplifier, phase shifter, or mixer in HR RF chain 426. 428 may have more efficient performance and/or more cost than the amplifier, phase shifter, or mixer in LR RF chain 422, 424. The ADC 416 in HR RF chain 426 has more efficient performance, more cost, larger number of bits, and/or higher sampling frequency than the ADC 412, 414 in LR RF chain 422, 424. For example, the ADC 416 in HR RF chain 426 may have more than 10 bits. The ADC 412, 414 in LR RF chain 422, 424 may have less than 8 bits. In an embodiment, the first part 408 and the second part 410 can be used by UE (or base station) at the same time. In an embodiment, the first part 408 and the second part 410 can be used by UE (or base station) at different time.

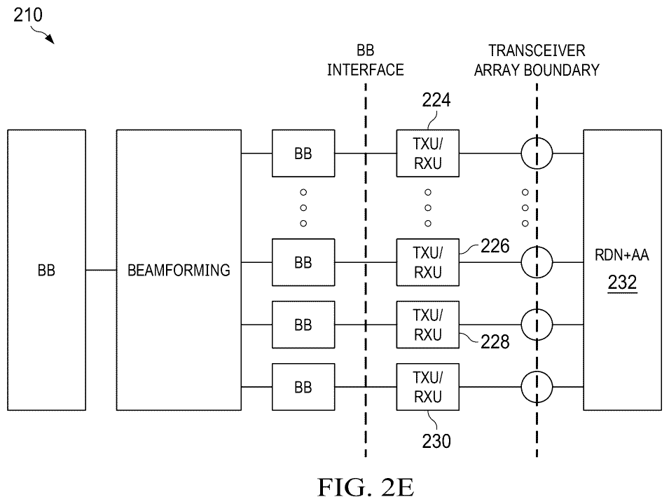

FIG. 5 illustrates a diagram of an embodiment procedure 500 for UE side to derive a downlink beam. A downlink beam is referred to as a downlink reference signal (RS). Beam derivation (or acquisition) for downlink is performed by user equipment (UE) using the LR digital RX panel(s) with digital beamforming by receiving signal from base station and deriving the best Tx beam(s) (e.g., with highest reference signal received power (RSRP), or the RSRP value being equal to or greater than an RSRP threshold) through baseband processing. If RX beam acquisition is performed by UE, the LR RF chain (e.g., in terms of low number of bits (e.g., being equal to or less than 8 bits) and sampling frequency for ADC) can be used, which significantly reduces cost and power consumption for UE side. It is not needed to perform beam sweeping procedures for RX beam acquisition of UE side as in the case of the analog/hybrid antenna array with HR RF chains (e.g., in terms of high number of bits (e.g., being greater than 10 bits) and sampling frequency for ADC). Acquired RX beam(s) are then applied for data/control channel reception and transmission (e.g., based on the analog/hybrid array with HR RF chains (e.g., in terms of high number of bits (e.g., being greater than 10 bits) and sampling frequency for ADC), for example, assuming beam correspondence being applied. The acquired RX beam(s) and the best Tx beam(s) are paired at UE as a beam pair. UE can determine the acquired RX beam(s) based on an indication of the TX beam(s) from the base station (e.g., in later on beam indication procedures).

In an embodiment, the UE may receive one or more RRC messages indicating a plurality of RSs (or configuring a plurality of RSs for the UE) (step 502). Each of the plurality of RSs is referred to as a downlink beam. The plurality of RSs may include a plurality of SSBs. The plurality of RSs may include a plurality of CSI-RSs. The UE receives an RS from the plurality of RSs based on the LR-digital RX panel (step 504). The UE determines an RX beam for the RS based on the LR digital RX panel with digital beamforming in baseband and without beam sweeping (step 506). Similarly, the UE determines an RX beam for each of the plurality of RSs based on the LR digital RX panel with digital beamforming in baseband and without beam sweeping (step 508). The UE may determine a first RS from the plurality of RSs based on detection via the LR digital RX panels with digital beamforming without beam sweeping. For example, the UE may determine the first RS in response to a RSRP value, of the first RS, being equal to or greater than an RSRP threshold value. The one or more RRC messages configure the RSRP threshold value. The first RS may be the best TX beam. The acquired RX beam for the first RS and the first RS are paired by the UE as a beam pair. The UE can determine the RX beam based on an indication of the first RS (e.g., DCI indicating transmission configuration indication (TCI) including the first RS). The UE may transmit an uplink signal indicating the first RS (or the first beam) to base station (step 510). The uplink signal may include an SRS resource, a PUCCH, a preamble, or a preamble transmitted via a PRACH occasion. In an embodiment, after receiving the uplink signal, base station may transmit one or more downlink signals to the UE based on the first RS (or first beam). The UE may receive the one or more downlink signals from the base station or transmit one or more uplink signals to the base station based on the first RS (or first beam) via the HR RF chain(s) (step 512). For example, the UE may receive the one or more downlink signals from the base station based on the derived RX beam corresponding to (or paired with) the first RS (or first beam) via the HR analog/hybrid RX panel. The one or more downlink signals may include PDCCH, PDSCH, SSB, and/or CSI-RS. In an embodiment, the UE may transmit one or more uplink signals to the base station based on the first RS via the HR digital TX panel(s) with analog/hybrid beamforming. The one or more uplink signals may include PUCCH, PUSCH, SRS, and/or Preamble.

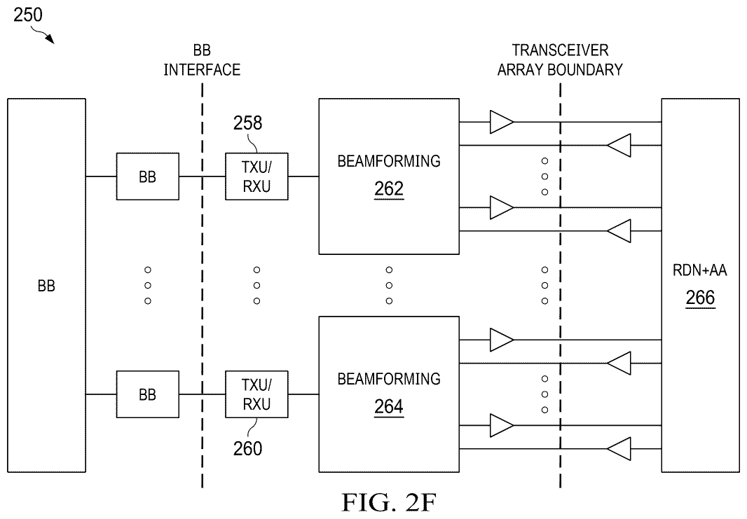

FIG. 6 illustrates a diagram of an embodiment procedure 600 for BS side. In the embodiment, the BS may transmit one or more RRC messages indicating a plurality of RSs (step 602). The one or more RRC messages include system information transmitted on physical broadcast channel (PBCH) (e.g., MIB message) or system information transmitted on physical downlink shared channel (PDSCH) (e.g., SIB message). Each of the plurality of RSs is referred to as a downlink beam. The plurality of RSs may include a plurality of SSBs. The plurality of RSs may include a plurality of CSI-RSs. The BS may transmit the plurality of RSs to UE with beam sweeping (step 604). The UE receives the plurality of RSs based on the LR RF chains with digital beamforming in baseband and without beam sweeping. The UE may determine a first RS from the plurality of RSs based on detection via the LR RF chains with digital beamforming without beam sweeping. For example, the UE may determine the first RS in response to a RSRP value, of the first RS, being equal to or greater than an RSRP threshold value. The one or more RRC messages indicates the RSRP threshold value. In an embodiment, the BS may only transmit one RS to UE. UE may detect the one RS, via the LR RF chains with digital beamforming in baseband and without beam sweeping and based on an RSRP value of the one RS being equal to or greater than the RSRP threshold value. The BS may receive, from the UE, an uplink signal indicating the first RS (or the first beam) from the plurality of RSs (step 606). The uplink signal may include an SRS resource, a preamble, uplink control information (UCI) transmitted via PUCCH, or a preamble transmitted via a PRACH occasion. In an embodiment, after receiving the uplink signal, base station may transmit one or more downlink signals to the UE or receive one or more uplink signals from the UE based on the first RS (or first beam) (step 608). The UE may receive the one or more downlink signals from the base station based on the first RS (or first beam) via the HR RF chain(s). The one or more downlink signals may include PDCCH, PDSCH, SSB, and/or CSI-RS. In an embodiment, the BS may receive one or more uplink signals from the UE based on the first RS (or first beam). The one or more uplink signals may include PUCCH, PUSCH, SRS, and/or Preamble.

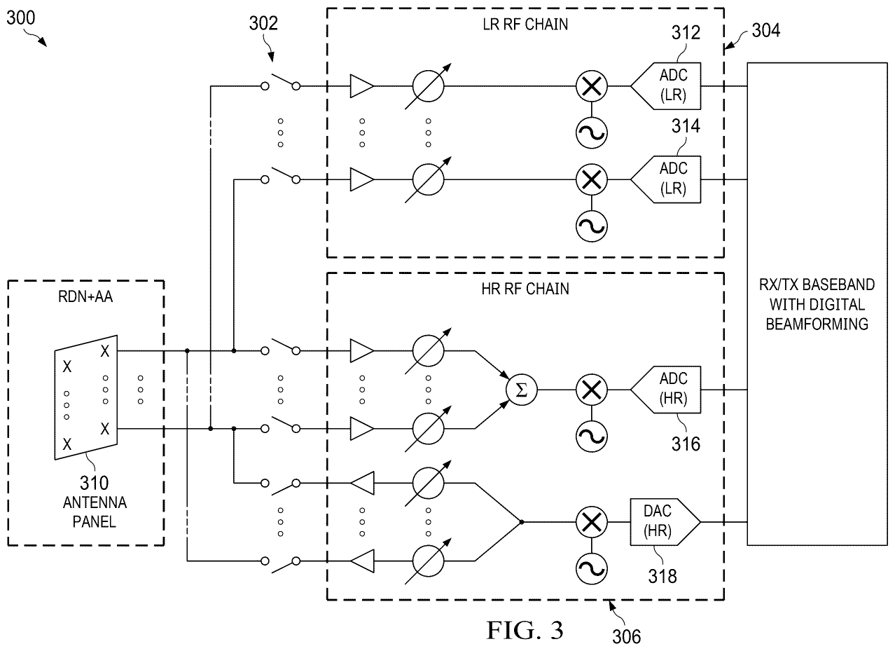

FIG. 7 illustrates a diagram of an embodiment procedure 700 for BS side. In an embodiment, base station may transmit one or more RRC messages indicating one or more resources for an uplink signal (step 702). The one or more RRC messages may include: system information transmitted on physical broadcast channel (PBCH) (e.g., MIB message), system information transmitted on physical downlink shared channel (PDSCH) (e.g., SIB message), or RRC messages transmitted in RRC connected state. The one or more resources may be time domain resources, frequency domain resources, preamble indexes, sounding reference signal (SRS) resources, or random access occasions. The uplink signal may be preambles, SRS, or UCI via PUCCH. The base station receives the uplink signal via the one or more resources (e.g., preamble via random access occasion, SRS with SRS resource, or UCI via PUCCH) based on the LR digital RX panel (e.g., with digital beamforming in baseband and without beam sweeping) (step 704). The base station may determine a first RX beam/RS based on detection of the uplink signal via the LR digital RX panels with digital beamforming without beam sweeping (step 706). For example, the base station may determine the first RX beam/RS in response to a RSRP value, of the uplink signal, being equal to or greater than an RSRP threshold value. In an embodiment, the one or more RRC messages indicates the RSRP threshold value. The first RX beam/RS and the uplink beam used for the uplink signal are pared by the base station. The base station can determine the first RX beam/RS based on detection of transmission of the uplink signal. The base station may transmit a downlink signal indicating the first RX RS (or the first RX beam) to UE (step 708). For example, the base station transmits the downlink signal indicating the uplink signal to UE. The downlink signal may be DCI transmitted via PDCCH. In an embodiment, after transmitting the downlink signal, base station may transmit one or more downlink signals to the UE based on the first RX RS (or first RX beam) (e.g., base station determines a downlink beam for the transmission of the one or more downlink signals based on beam correspondence capability of base station) and the HR digital panel. The UE may receive the one or more downlink signals from the base station based on a beam of the uplink signal corresponding to (or paired with) the first RX RS (or first RX beam) (e.g., UE determines a RX beam for the reception of the one or more downlink signals based on beam correspondence capability of UE). The one or more downlink signals may include PDCCH, PDSCH, SSB, and/or CSI-RS. In an embodiment, the UE may transmit one or more uplink signals to the base station. The base station may receive the one or more uplink signals or transmit the one or more downlink signals based on the first RX RS/beam via the HR digital RX panel(s) with digital beamforming (step 710). The one or more uplink signals may include PUCCH, PUSCH, SRS, and/or Preamble.

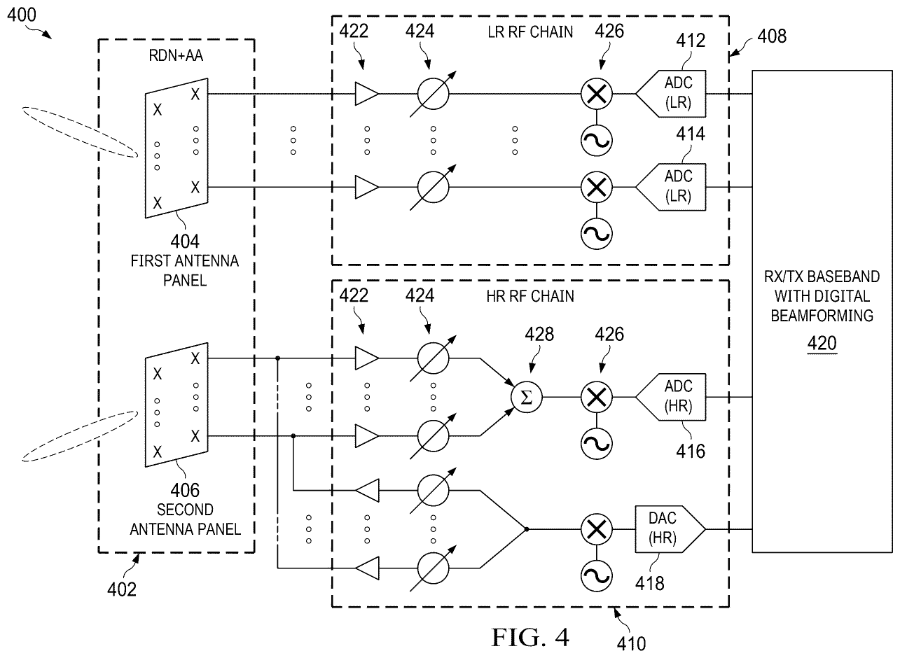

FIG. 8 illustrates a diagram of an embodiment procedure 800 for UE side. In an embodiment, UE may receive one or more RRC messages indicating one or more resources for an uplink signal (step 802). The one or more RRC messages may include: system information transmitted on physical broadcast channel (PBCH) (e.g., MIB message), system information transmitted on physical downlink shared channel (PDSCH) (e.g., SIB message), or RRC messages transmitted in RRC connected state. The one or more resources may be time domain resources, frequency domain resources, preamble indexes, sounding reference signal (SRS) resources, or random access occasions. The uplink signal may be preamble, SRS, or UCI via PUCCH. The UE transmits the uplink signal via the one or more resources (e.g., preamble via random access occasion, SRS with SRS resource, or UCI via PUCCH) (step 804). The base station may determine a first RX RS/beam based on detection of the uplink signal via the LR digital RX panels with digital beamforming without beam sweeping. For example, the base station may determine the first RX RS/beam in response to a RSRP value, of the uplink signal, being equal to or greater than an RSRP threshold value. In an embodiment, the one or more RRC messages indicates the RSRP threshold value. The UE may receive a downlink signal indicating the first RX RS (or the first RX beam) from the base station (step 806). The downlink signal may be DCI transmitted via PDCCH. In an embodiment, after receiving the downlink signal, the UE may receive one or more downlink signals from the base station based on the first RX RS (or first RX beam) (e.g., UE determines a RX beam for the reception of the one or more downlink signals based on beam correspondence capability of UE). The one or more downlink signals may include PDCCH (and the associated DMRS), PDSCH (and the associated DMRS), SSB, DMRS, and/or CSI-RS. In an embodiment, the UE may transmit one or more uplink signals or receive one or more downlink signals based on the first RX RS/beam (or based on a beam of the uplink signal) to the base station (step 808). The one or more uplink signals may include PUCCH, PUSCH, SRS, and/or Preamble.

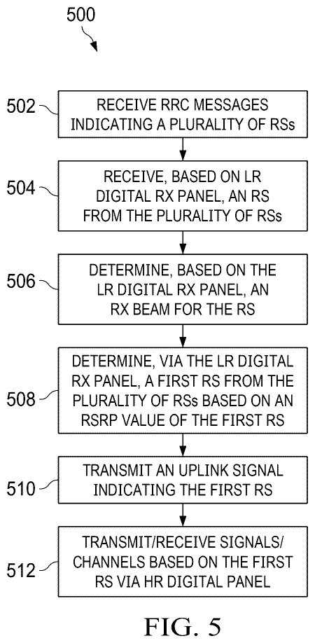

The procedures of beam management based on the LR digital RX panel and/or the HR digital TX/RX panel may include one or more of the following procedures: SSB acquisition, random access (RA) procedure, RX beam derivation, beam indication, beam confirmation, and beam failure detection and recovery procedure 900, as shown in FIG. 9. SSB acquisition (step 902) is a procedure in which UE acquire SSB (including its sequence(s), timing, frequency location, TX beam, and PBCH message) based on the LR digital RX panel and/or the HR digital RX panel. RA procedure (step 904) is a procedure in which UE perform a random-access procedure based on the LR digital RX panel and/or the HR digital TX/RX panel. RX beam derivation (step 906) is a procedure in which UE (or base station) performs RX beam acquisition (and the associated timing synchronization, frequency synchronization and doppler estimation) based on a received RS. Beam application (step 908) is to apply the RX beam acquired based on the LR digital RX panel to the transmission and/or reception of channels/signals using the HR-digital TX/RX panel. Beam confirmation (step 910) is a procedure in which UE or base station confirm the acquired beam with the counterpart of the communication. Beam indication (step 912) is a procedure in which UE or base station indicates the acquired beam to the counterpart of the communication for further communication using the acquired beam. Beam failure detection and recovery procedure (step 914) is a procedure in which UE or base station can detect beam failure and recover acquired beam with assistant of the counterpart of the communication.

### Ssb Acquisition.

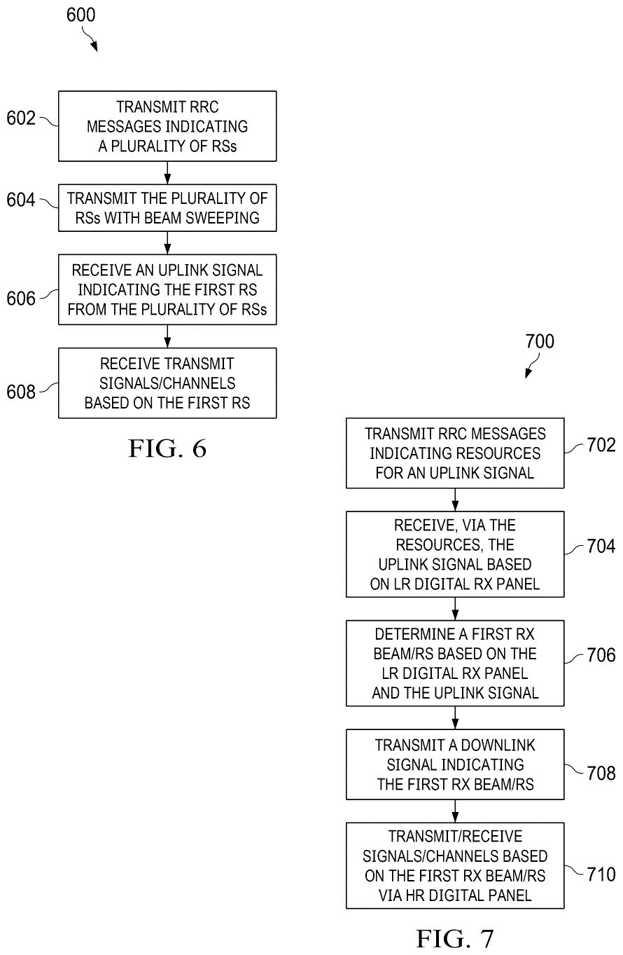

FIG. 10 illustrates a diagram of an embodiment procedure 1000 for beam derivation of downlink. Base station 1002 may transmit multiple downlink beams (e.g., including beam 1, beam 2, beam 3, beam 4) with beam sweeping. Beam sweeping is a procedure in which base station 1002 (or UE 1004) transmits each of the multiple downlink (or uplink) beams in a respective time instance and each of the multiple downlink (or uplink) beams covers a respective area of a cell (or a spatial direction). Each of the multiple downlink beams is referred to as (or associated with) an SSB (or a CSI-RS or SRS). For example, downlink beam 1 is referred (or associated) to as SSB1. Downlink beam 2 is referred to as SSB2. Downlink beam 3 is referred to as SSB3. Downlink beam 4 is referred to as SSB4. BS 1002 transmits one or more RRS messages indicating SSBs (S1010). The BS 1002 may then transmit the SSB1, SSB2, SSB3, SSB4 (S1011). In an embodiment, UE 1004 can acquire beam(s) (or SSB(s)) to access the network, for example, during initial access (IA) procedure. In an embodiment, UE 1004 can acquire beam(s) (or SSB(s)) to determine its reception beam or transmission beam, for example, during RRC connection state. UE can obtain coarse time/frequency synchronization and downlink beam associated with SSB(s) based on SSBs detection (e.g., with the LR RF chain (e.g., in terms of low number of bits (e.g., being equal to or less than 8 bits) and sampling frequency for ADC)) during IA (or based on CSI-RSs during IA or later stage in RRC connected state) (S1012). Base station 1002 may perform downlink beam sweeping (via SSB(s)) to ensure coverage of the multiple downlink beams (or the multiple SSBs). In an embodiment, base station 1002 determines initial TX beam for beam sweeping (of wide beam width). For example, base station 1002 determines initial TX beam(s) of a beam sweeping order. Base station 1002 transmits corresponding initial TX beam(s) according to the beam sweeping order (S1011). In an embodiment, BS 1002 determines initial TX beam based on other carrier/band beam information. For example, crossing carrier/band beam information indicates the initial TX beam. In an embodiment, BS 1002 determines initial TX beam based on artificial intelligence (AI)/machine learning (ML) algorithm prediction. UE 1004 can derive its RX beam(s) for the corresponding downlink beam/SSB which is faster without RX beam sweeping based on the LR RF chain(s) with digital beamforming (S1012). UE 1004 performs primary synchronization signal (PSS)/secondary synchronization signal (SSS) searching, time/frequency (T/F) synchronization and downlink beam acquisition, as well as RX beam derivation. The step of RX beam derivation without RX beam sweeping (S1012) adds processing complexity in digital domain in baseband with the benefit of faster downlink beam derivation.

In an embodiment, the BS 1002 may transmit one or more RRC messages indicating the multiple SSBs (or the multiple downlink beams) (e.g., SSB1, SSB2, SSB3, SSB4) to the UE 1004 (S1010). In an embodiment, the one or more RRC messages include system information transmitted on physical broadcast channel (PBCH) (e.g., MIB message) or system information transmitted on physical downlink shared channel (PDSCH) (e.g., SIB message). In an embodiment, BS 1002 can acquire an uplink beam via receiving uplink reference signal for BS RX beam derivation. The UE 1004 may determine an SSB from the multiple SSBs based on the LR RF chain with digital beamforming and without beam sweeping (S1012). For example, the UE 1004 may determine the SSB with an RSRP value being equal to or greater than an RSRP threshold value based on detection via the LR RF chain with digital beamforming in baseband and without beam sweeping in UE side. After determining the SSB from the multiple SSBs (S1012), the UE 1004 may transmit an uplink signal indicating the determined SSB to BS 1002 (S1014). In an embodiment, the UE 1004 may transmit the uplink signal based on a downlink RX beam corresponding to the SSB (e.g., the UE 1004 having capability of beam correspondence). In response to receiving the uplink signal, the BS 1002 may transmit, to the UE, downlink signals including PDCCH (and associated DMRS), PDSCH (and associated DMRS), and/or CSI-RS based on the downlink beam corresponding to the SSB, or based on the RX beam derived based on the uplink signal (S1016). The UE 1004 may receive the downlink signals including PDCCH, PDSCH, CSI-RS using the RX beam derived based on the downlink beam corresponding to the SSB. In an embodiment, the UE 1004 may transmit PUCCH (and associated DMRS), PUSCH (and associated DMRS), and/or SRS based on the downlink beam corresponding to the SSB (S1018). For example, the UE 1004 may determine an uplink TX beam based on the downlink RX beam with capability of beam correspondence. The UE 1004 may transmit PUCCH, PUSCH, and/or SRS with the uplink TX beam determined based on the downlink RX beam and the capability of beam correspondence.

### Ra Procedure.

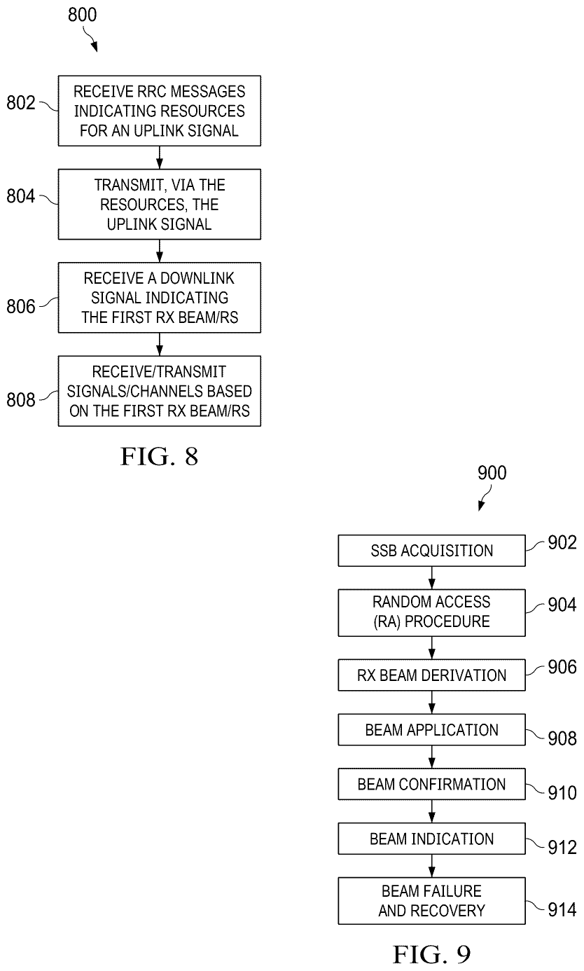

FIG. 11 illustrates a diagram of an embodiment procedure 1100 for random access. UE 1104 can acquire beam(s) to access the network, for example, via a random access procedure (e.g., contention based random access). UE 1104 can obtain coarse time/frequency synchronization and downlink (DL) beam associated with SSB(s) based on SSBs detection (e.g., with the LR digital RX panel (e.g., in terms of low number of bits (e.g., being equal to or less than 8 bits) and sampling frequency for ADC) or with the HR digital RX panel (e.g., in terms of high number of bits (e.g., being greater than 8 bits) and sampling frequency for ADC)) during random access (or based on CSI-RSs during handover or RRC connection status). During random access, BS 1102 may perform downlink beam sweeping (via SSB(s)) to ensure coverage of random (or initial) access (for legacy UEs and/or the UE 1104). In an embodiment, BS 1102 determines initial TX beam based on beam sweeping procedure (of wide beam width). For example, BS 1102 determines initial TX beam(s) for a beam sweeping order. BS 1102 transmits corresponding initial TX beam(s) according to the beam sweeping order. In an embodiment, BS 1102 determines initial TX beam based on other carrier/band beam information. For example, BS 1102 determines the initial TX beam if the crossing carrier/band beam information indicates the initial TX beam. In an embodiment, BS 1102 determines initial TX beam based on artificial intelligence (AI)/machine learning (ML) algorithm prediction. UE 1104 can derive its RX beam(s) for the corresponding DL beam/SSB (faster without RX beam sweeping based on the LR RF chain(s) with digital beamforming). UE 1104 can perform primary synchronization signal (PSS)/secondary synchronization signal (SSS) searching, time/frequency (T/F) synchronization and DL beam acquisition, meanwhile adding complexity for RX beam derivation in digital domain with the benefit of faster access of channel.

In an embodiment, UE 1104 may receive one or more RRC messages (S1110) from BS 1102. In an embodiment, the one or more RRC messages include system information transmitted on physical broadcast channel (PBCH) (e.g., MIB message) or system information transmitted on physical downlink shared channel (PDSCH) (e.g., SIB message). The one or more RRC messages may indicate a plurality of RSs. The plurality of RSs may include: a plurality of SSBs; or a plurality of CSI-RSs. Each of the plurality of RSs is referred to as a downlink beam. The one or more RRC messages may indicate an association between the RSs and random access resources. The random access resources include: one or more preambles, and/or one or more random access occasions. The UE 1104 may receive the one or more RRC messages from BS 1102 in RRC idle status, RRC inactive status, or RRC connection status. The association, between the RSs and random access resources, indicates that each of the RSs is associated with a respective preamble, a respective random access occasion, or a respective combination of preamble and random access occasion. The UE 1104 receives, based on the LR RF chain (or LR-digital RX panel) with digital beamforming, the plurality of RSs (S1112) from the BS 1102. After receiving the plurality of RSs, the UE 1104 determines an RS from the plurality of RSs based on the LR RF chain (or LR-digital RX panel) with digital beamforming in baseband (S1114). The UE 1104 determines a preamble and/or a random access occasion associated with the RS, for example, based on the association indicated by the one or more RRC messages. The UE 1104 transmits, to BS 1102, the preamble (i.e., Msg1 in the random access procedure) indicating the RS (S1116).

In an embodiment, the UE 1102 transmits, to BS 1104, the preamble using an uplink beam corresponding to the RS (e.g., UE 1104 determines the uplink transmit beam from the derived downlink RX beam based on the RS, according to the capability of beam correspondence). In an embodiment, the UE 1104 transmits, to BS 1102, the preamble using HR digital RX panel of the UE 1104. The UE 1104 receives, based on the RS, random access response (RAR) message (i.e., Msg2) (S1118) from the BS 1102. For example, the UE 1104 receives, using a same spatial filter as used for receiving the RS, the RAR message (i.e., Msg2) from the Bs 1102. In an embodiment, the UE 1104 receives, from the BS 1102, the RAR message using HR RF chain of the UE. The RAR message indicate an identifier of the preamble, uplink grant, and/or a timing advance (TA) value. The UE 1104 transmits an uplink transport block via PUSCH (i.e., Msg3) (S1122) to the BS 1102 based on the RS. For example, the UE 1104 transmits, using an uplink beam corresponding to the RS (e.g., UE determine the uplink transmit beam from the derived downlink RX beam based on the RS, according to the capability of beam correspondence), Msg3 to the Bs 1102. In an embodiment, the UE 1104 transmits, to the BS 1102, the Msg3 using HR RF chain of the UE 1104. The Msg3 may indicate an identifier (e.g., C-RNTI, temporary RNTI, or other identifier of core network) of the UE 1104. The UE 1104 receives, based on the RS, a downlink transport block via PDSCH (i.e., Msg4) (S1124) from the BS 1102. For example, the UE 1104 receives Msg4 from the BS 11-2 using the same spatial filter as used for receiving the RS. In an embodiment, the UE 1104 receives, from the BS 1102, the Msg4 using HR RF chain of the UE 1104. The Msg4 indicate the identifier of the UE (e.g., C-RNTI, temporary RNTI, or other identifier of UE 1104 for core network). In an embodiment, UE 1104 may transmit a UE capability message to BS 1102, for example, after UE 1102 accesses the network. The UE capability message may indicate, to the BS 1102, the LR digital RX panel and/or the HR digital TX/RX panel of the UE. Based on the UE 1104 capability message, the BS 1102 may indicate/configure UE 1104 to use one or more of the LR digital RX panel and the HR digital RX panel of the UE 1104 for transmission uplink signals/reception downlink signals. In another embodiment, UE 1104 may transmit a UE capability message to the BS 1102, for example, during initial access before the UE 1104 accesses the network. The UE capability message may indicate, to the BS 1102, the digital RX panel of the UE 1104 via a specific/separate set of PRACH preamble(s)/occasion, a field/signaling in MSG3, or the combination of them.

### RX Beam Derivation (Step 3). General Processing of RX Beam Derivation (Including Timing/Delay and Frequency/Doppler Offset Derivation) in Baseband Using LR-Digital RX Panel

In some embodiments, when a transmitter transmits a signal to the receiver equipped with one or more LR-digital RX panels, the receiver receives the signal and derives one or more receive beams for the signal, and the receive beams may include one or more digital receive beams each associated with a set of digital beamforming/combining weights, one or more analog receive beams each associated with a set of analog phase shift values (also known as analog beamforming weights), and one or more hybrid receive beams each associated with a set of analog phase shift values and a set of digital beamforming/combining weights (also known as hybrid beamforming weights). The receive beams can be applied to subsequent transmissions (after a generally non-negligible processing time), and the transmission beams may use the same set of analog phase shift values and/or set of digital beamforming/combining weights.

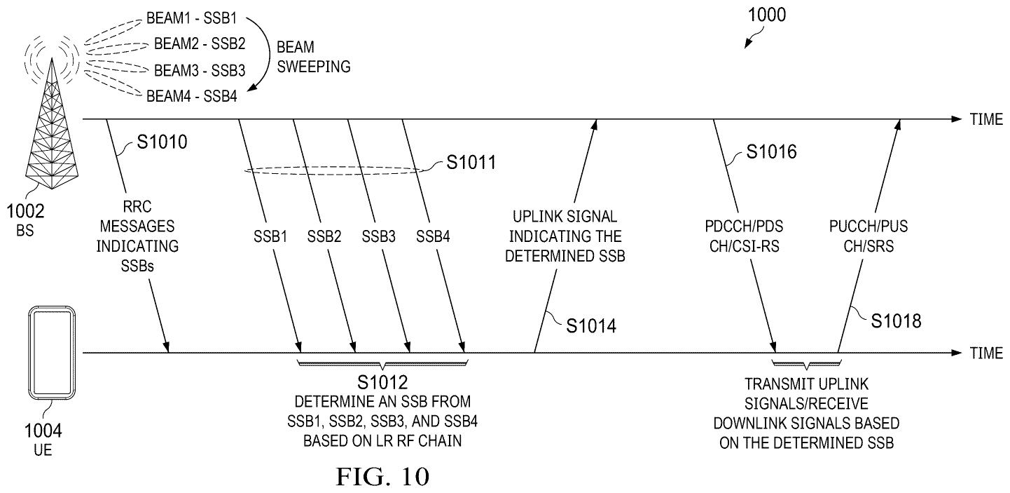

FIG. 12 illustrates a diagram of an embodiment procedure 1200 for RX beam derivation based on a downlink transmission. The signal used to derive the receive beams may be a DL SSB, CSI-RS, TRS, or a downlink RS for beam management sent from the gNB to the UE (S1206), as shown in FIG. 12, in which case the transmitter 1204 is the gNB transmitter and the receiver 1202 is the UE receiver. The receiver 1202 receives the SSB/CSI-RS/TRS from the transmitter 1204 on the LR-digital panel (S1208). The receiver 1202 derives one or more RX beams based on the SSB/CSI-RS/TRS (S12110) and applies the spatial filter for TX/RX on the analog/hybrid panels (S1212). The transmitter 1204 applies the spatial filter for TX/RX in accordance with the SSB/CSI-RS/TRS (S1214). The receiver 1202 and transmitter 1204 may then exchange UL/DL signals/channels (S1216).

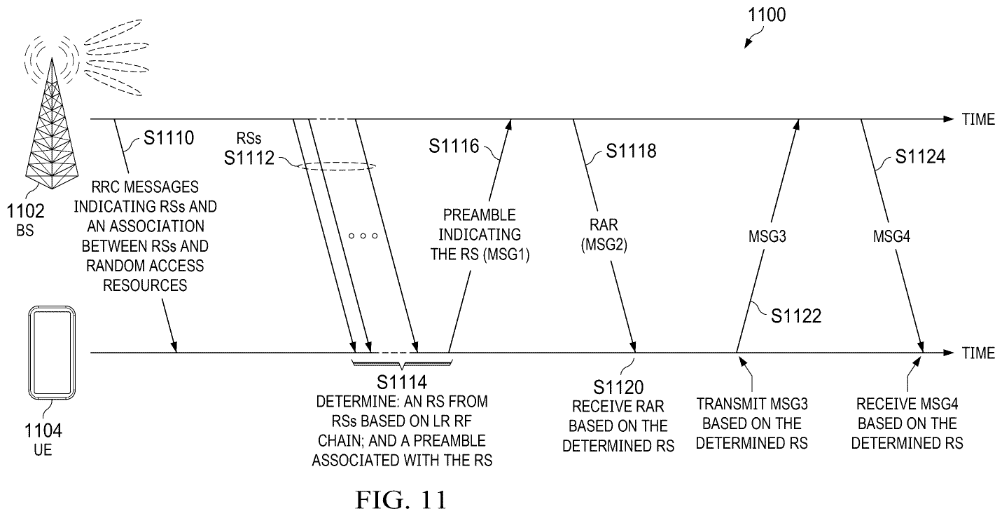

FIG. 13 illustrates a diagram of an embodiment procedure 1300 for RX beam derivation based on an uplink transmission. The signal used to derive the receive beams may be an UL SRS, a PRACH preamble, or an uplink RS for beam management sent from the UE to the gNB (S1306), in which case the transmitter 1304 is the UE transmitter, and the receiver 1302 is the gNB receiver, as shown in FIG. 13, in which case the transmitter is the UE transmitter and the receiver is the gNB receiver.

When the receiver 1302 receives the signal, the receiver receives a waveform signal from the transmitter on the LR-digital panel (S1308) and processes the waveform signal. The signal processing here based on the LR-digital RX panels, in general done in the digital domain which is normally performed in baseband, may include sampling, analog/digital (A/D) conversion, receiver's digital combining with combining weighting which effectively is RX beam acquisition, etc. (S1310). In some embodiments, such as in initial access where the UE having acquire DL time/frequency synchronization transmits a PRACH preamble, additional processing is needed, such as timing acquisition/synchronization, which generally involves (fine) time tracking (FFT window placement), frequency acquisition/synchronization, which generally involves (fine) frequency tracking, delay spread estimation, and Doppler spread estimation, etc. Embodiments of RX beam acquisition, tracking, and delay/Doppler spread estimation will be provided below. The receiver 1302 may apply the spatial filter for TX/RX on analog/hybrid panels (S1312). The transmitter 1304 may apply the spatial filter for TX/RX in accordance with the PRACH/SRS (S1314). The receiver 1302 and the transmitter 1304 may then exchange UL/DL signals/channels (S1316).

In some embodiments, the receive beam is derived based on the desired signal and optionally, also on undesired interference. For example, if the receiver 1302 can apply combining weights on the outputs from different digital chains, then it can weigh the received value higher on some digital chain than some other digital chain, effectively creating a digital receive beam, and the digital receive can maximize a receive quality such as the combined signal strength (taking into account the complex phases), SNR, or SINR. Maximum ratio combining (MRC) is one example of such a digital RX beam acquisition method. For another, but simpler example, the receiver 1302 can apply different phase shifts on the outputs from different digital chains, so that the outputs can be aligned in phases and added up constructively, effectively creating a digital receive beam, and the digital receive can maximize a receive quality such as the combined signal strength (taking into account the complex phases), SNR, or SINR. Equal gain combining (EGC) is one example of such a digital RX beam acquisition method. Generally, the receiver 1302 may adjust so that the digital RX beam is aligned with the transmit beam (say, beam A) of the desired signal, and optionally it can discount the impact of interfering beam B. Therefore, beam B may contribute much less to the received power at the receiver 1302, i.e., the interfering beam may be suppressed or even in the null space if a certain receiver combining vector is applied, and the receive quality SINR is maximized. Note that the RX beamforming vector/combining vector may be in general applied in analog domain and/or digital domain; but in digital domain the receiver 1302 does the post-processing of the received signals in baseband, which is not limited by the receive phase shifter based analog beam and that is why the LR-digital RX panel is beneficial. Moreover, the receiver 1302 may need to transmit towards a direction based on beam A to the transmitter 1304, for this purpose it can select its TX beamforming vector/precoding vector to be equal to (or based on) the receiver combining vector by exploiting the channel reciprocity.

For example, after the receiver receives the waveform signal and the RF chain generates received signals in digital domain, several different vectors used for combining the received signals can be provided (e.g., by a certain component of the node). For each vector, a decision variable which is a measure of the receive quality can be generated, and hence the receiver can obtain several decision variables. Then the one with the optimal value is selected, and the associated vector is selected as the digital RX beam. This beam may be further associated with a transmission direction, and then the receiver will subsequently transmit on that direction. The receiver may also compute a suitable digital RX beam solving an optimal combining problem given the signals generated by the RF chains by considering both desired signal and undesired interference, generating a beam direction along which the composite channel has the highest SINR, and then receives and transmits along that direction.

In an embodiment, the digital RX beam is a receiver combining vector/matrix, wherein determining the receiver combining vector/matrix includes obtaining a waveform received by the analog components of the receive antennas in accordance with the analog components' analog phase shifts; determining a plurality of combining vectors/matrices; generating a plurality of decision variables according to the plurality of combining vectors/matrices by applying the vectors/matrices to the outputs of the waveform; and selecting one of the plurality of combining vectors/matrices as the receive combining vector/matrix according to an optimal one of the plurality of decision variable. In other words, when the baseband digital unit processes the received waveform, it may apply different digital combining vectors/matrices (e.g., p₁, p₂, p₃, . . . , where each pᵢ is vector/matrix) to the waveform, generating different decision variables X₁, X₂, X₃, . . . . Then the digital combining vector/matrix associated with the optimal X is used. An optimization problem may be solved by the baseband to find the optimal direction among all possible directions.

In some embodiments, the tracking functionalities also need to be performed by a receiver based on the signal: fine time tracking, fine frequency tracking, delay spread estimation and Doppler spread estimation. The signal used for tracking and channel estimation is generally a signal commonly known to the transmitter and receiver. The known signal is typically a spread signal (or a sequence) with a certain length, which can provide spreading gain, and the longer the known signal, the higher the spreading gain. The spreading gain can also be helpful for the receiver to derive a receive beam (see above embodiments) based on the known signal, even if the SNR at each digital chain is below the noise level. The spreading gain and the receive beamforming gain together, when designed properly, can be sufficiently high such that RX beam and the associated delay offset and Doppler/frequency offset can be derived with high accuracy. A rough estimate is as follows. With a proper beam pair, the beamformed SINR of a modulation symbol for a channel/RS should not be very low, say >−10 dB. Therefore, with a proper (initial) TX beam, the SINR at each RX antenna needs to be larger than a threshold of −10-10*log 1010 log 10 (# of RX antennas) dB. Processing over the known signal of sufficient length should bring the SINR to be sufficiently high, which can be above the threshold.

In fine time tracking, the receiver detects the first arriving path and optimally places its Fast Fourier transform (FFT) window to maximize data signal to noise plus inter-symbol interference ratio. In continuous operation, the optimal FFT window position will drift because of UE mobility and residual oscillator error between the transmitter and receiver. The receiver adjusts its FFT window placement based on the detected change of path arriving time.

In fine frequency tracking, the receiver detects the frequency offset between the transmitter and receiver and may adjust its oscillator accordingly. The residual frequency error is estimated and compensated in demodulation of data symbols. The residual error compensation can be used in the case of high signal-to-noise ratio (SNR) and high code rate data transmission. Uncompensated frequency error imposes phase error on the modulated data symbol and results in decoding performance degradation. Because temperature change affects the output precision of oscillator and Doppler shift caused by UE movement, the receiver should periodically track the frequency offset and apply the corresponding adjustment and compensation.

Delay spread determines how dispersive of the wireless multi-path channel the receiver experiences. The longer the delay spread, the more frequency selective the channel is. To maximize the potential processing gain along the frequency domain in channel estimation based on the received pilot (reference) signal, the receiver strives to apply linear filtering with length as long as possible if within the coherence bandwidth. Coherence bandwidth is inversely proportion to its channel selectiveness. Thus delay spread estimation plays a role in forming channel estimation filter coefficients and length, hence the performance of channel estimation and data demodulation.

Doppler spread is usually proportional to UE movement speed and multi-path spatial distribution. Larger Doppler spread is corresponding to faster changing wireless multi-path fading channel. Channel estimation usually applies the filtering in the time domain with longer filter length to suppress the noise plus interference if within the channel coherence time constraint. Doppler spread estimation is thus another factor along time domain affecting UE channel estimation performance.

The above tracking and delay/Doppler spread estimation may be done by the receiver separately from the beam acquisition. However, in some scenarios such as initial access, at least before the time tracking of FFT window placement is completed, the search of an optimizing RX combining vector cannot be done. In some embodiments, a joint operation to find two or more of the (sub-) optimal timing of FFT window, frequency adjustment and compensation, delay spread estimation, Doppler spread estimation, and combining vector/matrix may be done on samples buffered for the baseband processing unit from all the digital chains. In either case, the processing time to derive the RX beam(s) and other tracking/channel estimation information via LR-digital panel will not be negligible and can be (much) longer than a few OFDM symbols, especially since FR2 has short OFDM symbol duration. Such processing time can be used on the timing of application of the derived beam(s) and subsequent transmissions. In the case of DL UE RX beam acquisition, capability report from UE side is needed, such as UE reporting to the gNB the duration between receiving a DL RS (SSB/TRS/CSI-RS) to applying the spatial RX filter for UL transmission. In the case of UL gNB RX beam acquisition, as shown in FIG. 13, the gNB processing time may also need to be signaled to the UE, which is the duration between UE transmitting an UL signal (PRACH preamble or SRS) to gNB applying the spatial RX filter based on the UL signal for DL transmission; before such a duration completes, the UE should assume the default beam or the previous beam for proper RX at the UE, but after such a duration completes, the UE may assume the gNB applies a new TX beam based on the UL signal, and the UE may adjust its DL spatial RX filter accordingly. Note that the beam for each SRS/PRACH transmission (of a same SRS resource or PRACH occasion/preamble) can be different (and up to UE implementation/derivation in previous steps) and such information is relevant when applying the RX team for transmission.

One or more digital RX beams may be derived at the receiver of a gNB/UE. The gNB/UE may be capable of applying the multiple RX beams using its analog/hybrid RX/TX panels simultaneously and/or in a TDM fashion, which depends on the analog/hybrid panel design. In some embodiments, when more than 1 beam are derived, they can be applied at the same time for transmission/reception via different analog/hybrid panels especially in the case of MIMO transmission, e.g., two analog/hybrid panels are supported by a gNB, and each panel can be used for one beam, so that the gNB can TX/RX using two analog beams at the same time, which is useful for MIMO/beam diversity schemes. In some other embodiments, when more than 1 beam are derived, they have to be applied at different times, i.e., TDM, and to switch from one beam to another a beam switching time is required as the antennas have to apply a different set of analog phase shifting values. In some embodiments, the gNB/UE derives M RX beams from the signal using the LR-digital panel(s), while it can support N simultaneous analog/hybrid beams for TX/RX, where M>=N. Then a mixture of simultaneous multi-beam and beam switching may be applied.

### Indication Signaling (Step 4 and 5).

The BS, upon obtaining the beam(s) in the previous steps, may apply the beam(s) to DL transmission such as PDCCH, PDSCH, and/or CSI-RS transmissions. In order for the UE to properly receive the DL transmission using its analog receive panel, the BS may indicate to the UE what spatial filter the UE may use to receive the DL transmission. It should be appreciated that the term “beam”, “spatial filter”, “QCL”, and “QCL-TypeD” may be used interchangeably throughout this document. QCL is Quasi-co-location. In 3GPP Rel. 15/16/17, four QCL types are defined, including QCL-TypeA, QCL-TypeB, QCL-TypeC, and QCL-TypeD.

In one embodiment, a DL transmission using the beam(s) derived at the BS based on an UL SRS/PRACH transmission may be received at the UE using the spatial filter/beam that is used for transmitting the SRS/PRACH. Therefore, the BS may signal to the UE an indication includes information of the SRS or PRACH transmission. This information may include identification of the SRS resource used for the SRS transmission, or identification of the PRACH preamble used for the PRACH transmission. This information may also include indication of the transmission instance of the SRS/PRACH transmission if there is an ambiguity. The indication of the transmission instance may include frame offset, slot offset, and/or symbol offset associated with the transmission time of the SRS/PRACH transmission.

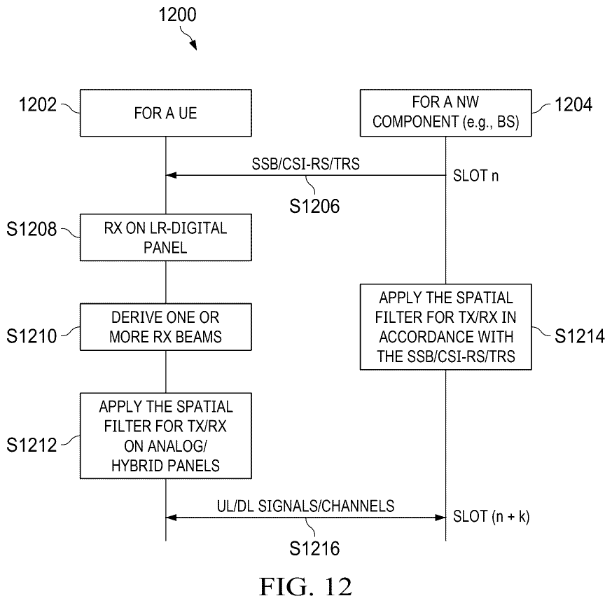

FIG. 14 illustrates a diagram of an embodiment procedure 1400 for beam indication. The UE 1404 may transmit an SRS/PRACH (S1406) to the BS 1402. In one example, the BS 1402 may transmit (S1408) a DCI message to the UE 1404, wherein the DCI message may include transmission configuration indication (TCI) field indicating TCI state(s). The TCI state(s) may include information of a plurality of source reference signals. Examples of the information of the source reference signal include resource identification (ID) of the source reference signal and channel index of the source reference signal, such as the SRS resource ID, the SRS resource set ID, the RACH preamble ID, CSI-RS resource ID, and the SSB index, etc. The source reference signal may be viewed as being associated with a beam, being a reference to a beam, being associated with a QCL-TypeD property, being a reference to a QCL-TypeD property, being associated with a spatial filter, and/or being a reference to a spatial filter. When the TCI state(s) indicated by the TCI field in the DCI message include SRS resource ID, SRS resource set ID, or RACH preamble ID as the information of the source reference signal, it indicates to the UE that the transmit spatial filter used for the transmission of the source reference signal associated with the SRS resource ID, the SRS resource set ID, or the RACH preamble ID, respectively, should be used as the receive spatial filter to receive the DL transmission(s) scheduled by the DCI message, or to receive the DL transmission(s) after the DCI message.

In another embodiment, BS may transmit a DL transmission using the same transmit spatial filter/beam that is used for transmitting a DL signal such as SSB, CSI-RS, or other beam management RS. The UE may receive the DL transmission using the same receive spatial filter/beam that is used to receive the DL signal. Therefore, the BS may indicate to the UE an indication includes information of the DL signal. This information may include identification of the DL signal such as the SSB index, CSI-RS resource ID, beam management RS ID, etc. This information may also include indication of the transmission instance of the DL signal if there is an ambiguity. The indication of the transmission instance may include frame offset, slot offset, and/or symbol offset associated with the transmission time of the DL signal.

In one example, the BS may transmit a DCI message to the UE, wherein the DCI message may include transmission configuration indication (TCI) field indicating TCI state(s). When the TCI state(s) indicated by the TCI field in the DCI message include SSB index, CSI-RS resource set ID, or beam management RS ID as the information of the source reference signal, it indicates to the UE that the receive spatial filter used for the reception of the source reference signal associated with the SSB index, the CSI-RS resource ID, or the beam management RS ID, respectively, should be used as the receive spatial filter to receive the DL transmission(s) scheduled by the DCI message, or to receive the DL transmission(s) after the DCI message.

Similarly, the UE, upon obtaining the beam(s) in the previous steps, may apply the beam(s) to UL transmission such as PUCCH, PUSCH, and/or SRS transmissions. In order for the BS to properly receive the UL transmission using its analog receive panel, the UE may indicate to the BS what spatial filter the BS may use to receive the UL transmission.

In one embodiment, an UL transmission using the beam(s) derived at the UE based on an DL SSB, CSI-RS, or beam management RS transmission may be received at the BS using the spatial filter/beam that is used for transmitting the DL SSB, CSI-RS, or beam management RS. Therefore, the UE may indicate to the BS an indication includes information of the DL SSB, CSI-RS, or beam management RS transmission. This information may include identification of the DL SSB, CSI-RS, or beam management RS. This information may also include indication of the transmission instance of the DL SSB, CSI-RS, or beam management RS transmission if there is an ambiguity. The indication of the transmission instance may include frame offset, slot offset, and/or symbol offset associated with the transmission time of the DL SSB, CSI-RS, or beam management RS transmission.

In one example, the UE may transmit an uplink control information (UCI) message to the BS, wherein the UCI message may include transmission configuration indication (TCI) field indicating TCI state(s). When the TCI state(s) indicated by the TCI field in the UCI message include SSB index, CSI-RS resource set ID, or beam management RS ID as the information of the source reference signal, it indicates to the BS that the transmit spatial filter used for the transmission of the source reference signal associated with the SSB index, the CSI-RS resource ID, or the beam management RS ID, respectively, should be used as the receive spatial filter to receive the UL transmission(s) associated with the UCI message.

In another embodiment, UE may transmit an UL transmission using the same transmit spatial filter/beam that is used for transmitting an UL signal such as SRS/PRACH. The BS may receive the UL transmission using the same receive spatial filter/beam that is used to receive the UL signal. Therefore, the UE may indicate to the BS an indication includes information of the UL signal. This information may include identification of the UL signal such as the SRS resource ID, SRS resource set ID, or RACH preamble ID, etc. This information may also include indication of the transmission instance of the UL signal if there is an ambiguity. The indication of the transmission instance may include frame offset, slot offset, and/or symbol offset associated with the transmission time of the UL signal.

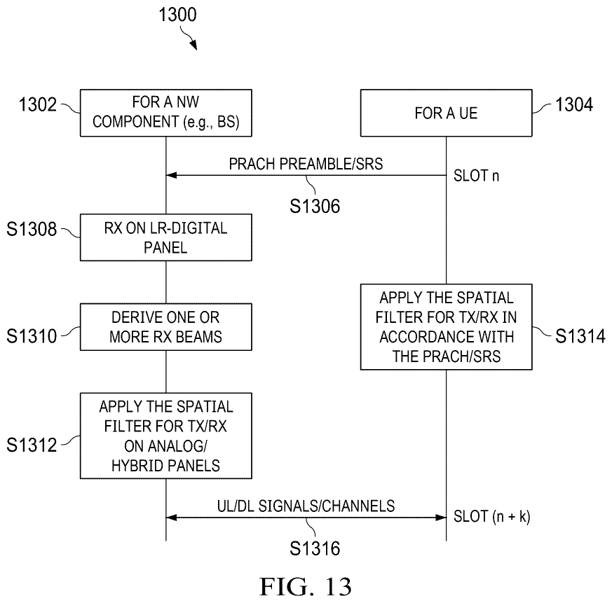

FIG. 15 illustrates a diagram of an embodiment procedure 1500 for beam indication. In an example, the UE 1504 may transmit an SRS/PRACH (sS1506) to the BS 1502. In one example, the UE 1504 may transmit (S1508) a UCI message to the BS 1502, wherein the UCI message may include transmission configuration indication (TCI) field indicating TCI state(s). When the TCI state(s) indicated by the TCI field in the UCI message include SRS resource ID, SRS resource set ID, or RACH preamble ID as the information of the source reference signal, it indicates to the BS that the receive spatial filter used for the reception of the source reference signal associated with the SRS resource ID, SRS resource set ID, or RACH preamble ID, respectively, should be used as the receive spatial filter to receive the UL transmission(s) associated with the UCI message.

In yet another embodiment, no explicit indication of receive/transmit spatial filter is needed between the BS and the UE. The UE/BS may decide the receive and/or transmit spatial filter according to rule(s). In one example, a rule is defined such that the UE uses the latest receive spatial filter used to receive a DL channel/signal as the transmit spatial filter for transmission of an UL channel/signal if the time gap between the DL channel/signal and the UL channel/signal is less than or equal to a threshold, e.g., 5 ms. In another example, a rule is defined such that the UE uses the latest receive spatial filter used to receive a first DL channel/signal as the receive spatial filter for reception of a second DL channel/signal if the time gap between the first DL channel/signal and the second DL channel/signal is less than or equal to a threshold. In yet another example, a rule is defined such that the UE uses the latest transmit spatial filter used to transmit a first UL channel/signal as the transmit spatial filter for transmission of a second UL channel/signal if the time gap between the first UL channel/signal and the second UL channel/signal is less than or equal to a threshold.

Similarly, in one example, a rule is defined such that the BS uses the latest receive spatial filter used to receive an UL channel/signal as the transmit spatial filter for transmission of a DL channel/signal if the time gap between the UL channel/signal and the DL channel/signal is less than or equal to a threshold, e.g., 5 ms. In another example, a rule is defined such that the BS uses the latest receive spatial filter used to receive a first UL channel/signal as the receive spatial filter for reception of a second UL channel/signal if the time gap between the first UL channel/signal and the second UL channel/signal is less than or equal to a threshold. In yet another example, a rule is defined such that the BS uses the latest transmit spatial filter used to transmit a first DL channel/signal as the transmit spatial filter for transmission of a second DL channel/signal if the time gap between the first DL channel/signal and the second DL channel/signal is less than or equal to a threshold.

### Beam Confirmation, Beam Failure Detection and Recovery (Step 6).

After deriving receive beam using LR-digital RX panel, either for reception or transmission using analog panel, beam (pair) confirmation may be needed because errors occur. The sources of errors may include signal processing and estimation/detection error (or even failure due to very high estimation error and unreliable detection) especially in low SINR case, reciprocity (beam correspondence) mismatch between LR-digital receive panel and the analog transmit panel, mismatch between LR-digital receive panel and the analog receive panel, and mobility/time-varying channel, etc.

In one embodiment, when the UE fails to derive/detect a beam using its LR-digital receive panel, the UE reports the deriving/detection failure to the BS. In one example, the UE send a signal (NACK) to the BS indicating the deriving/detection failure. On the other hand, the beam deriving/detection failure at the BS may be handled by BS implementation.

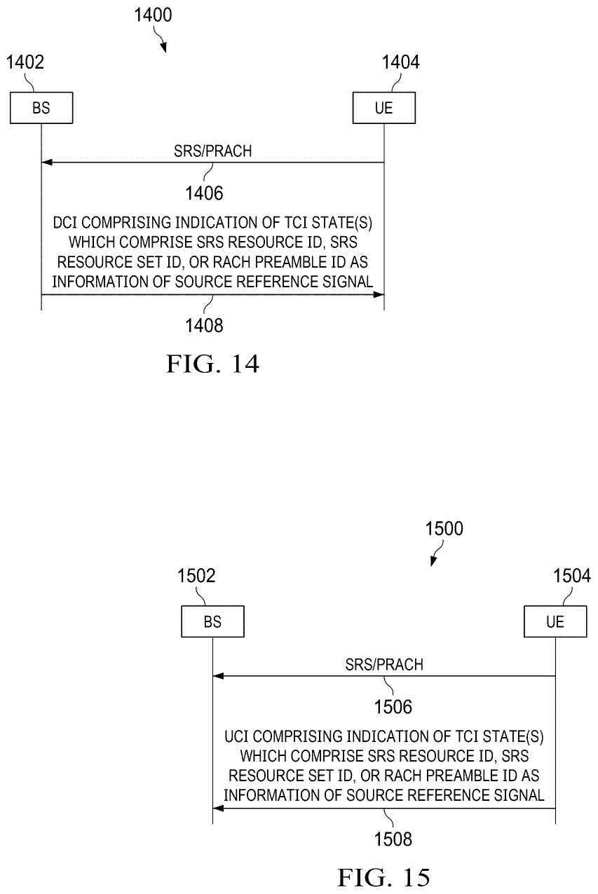

In another embodiment, when the BS successfully derives a receive beam using its LR-digital receive panel, the BS may confirm to the UE the derivation. FIG. 16 illustrates a diagram of an embodiment procedure 1600 for beam confirmation. The confirmation of a derived BS receive beam (S1606) may be carried by the BS 1602 by asking the UE 1604 to send an UL RS (S1608), which may be the same UL RS as the one used to derive the BS's receive beam, and by measuring the UL RS using the receive beam on the analog receive panel. Alternatively, the BS 1602 may transmit a DL RS using the derived receive beam and ask the UE 1604 to perform measurement on the DL RS using the spatial filter/beam used for transmission of the UL RS which is used by the BS to derive the BS's receive beam, and report CSI (e.g., RSRP) associated with the DL RS.

Confirmation of a derived UE receive beam may be performed in a similar way. In one embodiment, when the UE successfully derives a receive beam using its LR-digital receive panel, the UE may confirm to the BS the derivation. The confirmation of a derived UE receive beam may be carried by the UE by asking the BS to send a DL RS, which may be the same DL RS as the one used to derive the UE's receive beam, and by measuring the DL RS using the receive beam on the analog receive panel. Alternatively, the UE may transmit an UL RS using the derived receive beam such that the BS may perform measurement on the UL RS using the spatial filter/beam used for transmission of the DL RS which is used by the UE to derive the UE's receive beam.

After derivation and confirmation of beam(s), beam failure may occur due to mobility and blockage. Beam failure detection (BFD) and beam failure recovery (BFR) procedure is therefore needed. In 3GPP Rel. 15/16, the UE monitors periodic CSI-RS that are QCLed with PDCCH DMRS with respect to ‘QCL-TypeD’ for beam failure detection purpose. These periodic CSI-RS are referred as beam failure detection reference signals (BFD-RS). There could be multiple BFD-RS corresponding to multiple CORESETs. The UE monitors the quality of the BFD-RS and derives hypothetical PDCCH BLER. When a hypothetical PDCCH BLER is higher than a threshold for a number of consecutive instances, the corresponding BFD-RS is viewed as failed. A BFR is triggered only when all the BFD-RS fail. In 3GPP Rel. 17, TRP-specific BFD and BFR are supported, where a TRP-specific BFR may be triggered when all the BFD-RS in a BFD-RS set associated with a TRP fail.

As discussed previously, with the mixed architecture described herein, the TCI state(s) indicated by the TCI field in the DCI message may include SRS resource ID or SRS resource set ID as the information of a source reference signal. In this case, it is the SRS associated with the SRS resource ID or SRS resource set ID that is QCLed with the PDCCH DMRS with respect to ‘QCL-TypeD’. This is different from the cases in 3GPP Rel. 15/16/17 where it is the DL CSI-RS that is QCLed with the PDCCH DMRS with respect to ‘QCL-TypeD’. Hence it may not be feasible for the UE to monitor the quality of the SRS for BFD. In one embodiment, the SRS associated with the SRS resource ID or SRS resource set ID may serve as the BFD-RS. The BS may monitor the quality of the SRS for BFD purpose. The BS may monitor the quality of the SRS using a first derived receive beam and obtain a first quality value. The first derived receive beam may be the transmit beam being using for transmission of the PDCCH. In one example, the BS may derive hypothetical PDCCH BLER according to the first quality value. When the hypothetical PDCCH BLER is higher than a threshold for a number of consecutive instances, the first derived receive beam is viewed as failed. In another example, The BS may monitor the quality of the SRS using a second derived receive beam and obtain a second quality value. The second derived receive beam may be a candidate beam for transmission of the PDCCH. The BS may perform BFD according to the first and/or the second quality value. For example, the BS may compare the first and the second quality value. If the difference between the first and the second quality value is larger than a threshold for a number of consecutive instances, the first derived receive beam is viewed as failed.

As an alternative, with the new beamforming communication architecture, the beam management has much less overhead and faster training. Therefore, periodic beam derivation with relatively short periodicity can be performed followed by beam confirmation. As an example, a DL RS and an UL RS can be sent by the BS and the UE every L millisecond (e.g., 5 ms) to take turn to train the UE RX beam and the BS RX beam followed by beam confirmation. Effectively, beam failure can be detected through beam confirmation and beam failure recovery can also be done very fast. Alternatively, the BS can trigger DL RS and UL RS transmissions and beam confirmation frequently to achieve the same purpose.

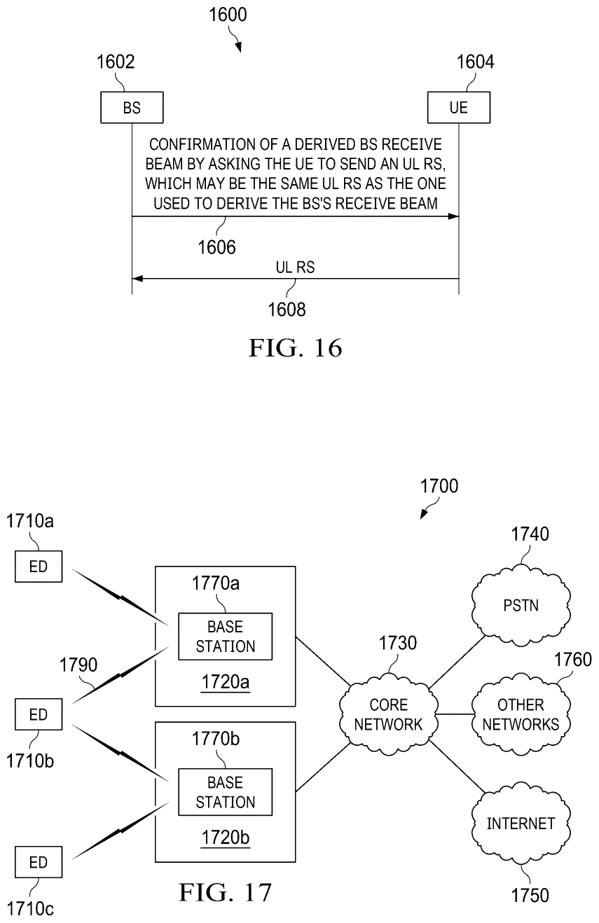

FIG. 17 illustrates an example communication system 1700. In general, the system 1700 enables multiple wireless or wired users to transmit and receive data and other content. The system 1700 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1700 includes electronic devices (ED) 1710a-1710c, radio access networks (RANs) 1720a-1720b, a core network 1730, a public switched telephone network (PSTN) 1740, the Internet 1750, and other networks 1760. While certain numbers of these components or elements are shown in FIG. 17, any number of these components or elements may be included in the system 1700.

The EDs 1710a-1710c are configured to operate or communicate in the system 1700. For example, the EDs 1710a-1710c are configured to transmit or receive via wireless or wired communication channels. Each ED 1710a-1710c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1720a-1720b here include base stations 1770a-1770b, respectively. Each base station 1770a-1770b is configured to wirelessly interface with one or more of the EDs 1710a-1710c to enable access to the core network 1730, the PSTN 1740, the Internet 1750, or the other networks 1760. For example, the base stations 1770a-1770b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1710a-1710c are configured to interface and communicate with the Internet 1750 and may access the core network 1730, the PSTN 1740, or the other networks 1760.

In the embodiment shown in FIG. 17, the base station 1770a forms part of the RAN 1720a, which may include other base stations, elements, or devices. Also, the base station 1770b forms part of the RAN 1720b, which may include other base stations, elements, or devices. Each base station 1770a-1770b operates to transmit or receive wireless signals within a particular geographic region or area, sometimes referred to as a “cell.” In some embodiments, multiple-input multiple-output (MIMO) technology may be employed having multiple transceivers for each cell.

The base stations 1770a-1770b communicate with one or more of the EDs 1710a-1710c over one or more air interfaces 1790 using wireless communication links. The air interfaces 1790 may utilize any suitable radio access technology.

It is contemplated that the system 1700 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1720a-1720b are in communication with the core network 1730 to provide the EDs 1710a-1710c with voice, data, application, Voice over Internet Protocol (VOIP), or other services. Understandably, the RANs 1720a-1720b or the core network 1730 may be in direct or indirect communication with one or more other RANs (not shown). The core network 1730 may also serve as a gateway access for other networks (such as the PSTN 1740, the Internet 1750, and the other networks 1760). In addition, some or all of the EDs 1710a-1710c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1750.

Although FIG. 17 illustrates one example of a communication system, various changes may be made to FIG. 17. For example, the communication system 1700 could include any number of EDs, base stations, networks, or other components in any suitable configuration.

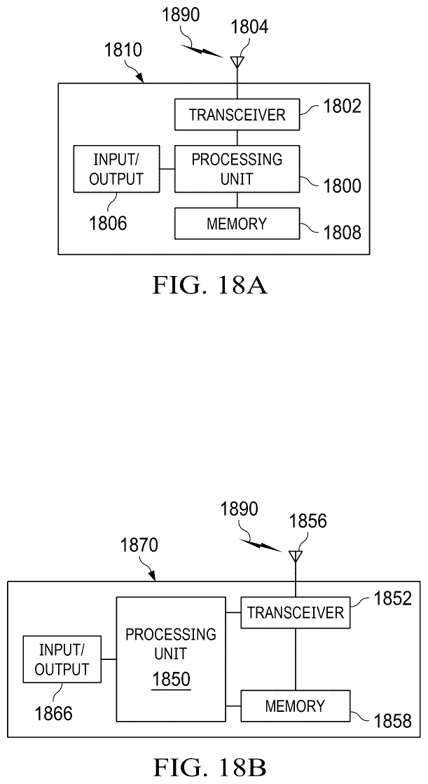

FIGS. 18A and 18B illustrate example devices that may implement the methods and teachings according to this disclosure. In particular, FIG. 18A illustrates an example ED 1810, and FIG. 18B illustrates an example base station 1870. These components could be used in the system 1700 or in any other suitable system.

As shown in FIG. 18A, the ED 1810 includes at least one processing unit 1800. The processing unit 1800 implements various processing operations of the ED 1810. For example, the processing unit 1800 could perform signal coding, data processing, power control, input/output processing, or any other functionality enabling the ED 1810 to operate in the system 1700. The processing unit 1800 also supports the methods and teachings described in more detail above. Each processing unit 1800 includes any suitable processing or computing device configured to perform one or more operations. Each processing unit 1800 could, for example, include a microprocessor, microcontroller, digital signal processor, field programmable gate array, or application specific integrated circuit.

The ED 1810 also includes at least one transceiver 1802. The transceiver 1802 is configured to modulate data or other content for transmission by at least one antenna or NIC (Network Interface Controller) 1804. The transceiver 1802 is also configured to demodulate data or other content received by the at least one antenna 1804. Each transceiver 1802 includes any suitable structure for generating signals for wireless or wired transmission or processing signals received wirelessly or by wire. Each antenna 1804 includes any suitable structure for transmitting or receiving wireless or wired signals. One or multiple transceivers 1802 could be used in the ED 1810, and one or multiple antennas 1804 could be used in the ED 1810. Although shown as a single functional unit, a transceiver 1802 could also be implemented using at least one transmitter and at least one separate receiver.

The ED 1810 further includes one or more input/output devices 1806 or interfaces (such as a wired interface to the Internet 1750). The input/output devices 1806 facilitate interaction with a user or other devices (network communications) in the network. Each input/output device 1806 includes any suitable structure for providing information to or receiving information from a user, such as a speaker, microphone, keypad, keyboard, display, or touch screen, including network interface communications.

In addition, the ED 1810 includes at least one memory 1808. The memory 1808 stores instructions and data used, generated, or collected by the ED 1810. For example, the memory 1808 could store software or firmware instructions executed by the processing unit(s) 1800 and data used to reduce or eliminate interference in incoming signals. Each memory 1808 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 18B, the base station 1870 includes at least one processing unit 1850, at least one transceiver 1852, which includes functionality for a transmitter and a receiver, one or more antennas 1856, at least one memory 1858, and one or more input/output devices or interfaces 1866. A scheduler, which would be understood by one skilled in the art, is coupled to the processing unit 1850. The scheduler could be included within or operated separately from the base station 1870. The processing unit 1850 implements various processing operations of the base station 1870, such as signal coding, data processing, power control, input/output processing, or any other functionality. The processing unit 1850 can also support the methods and teachings described in more detail above. Each processing unit 1850 includes any suitable processing or computing device configured to perform one or more operations. Each processing unit 1850 could, for example, include a microprocessor, microcontroller, digital signal processor, field programmable gate array, or application specific integrated circuit.

Each transceiver 1852 includes any suitable structure for generating signals for wireless or wired transmission to one or more EDs or other devices. Each transceiver 1852 further includes any suitable structure for processing signals received wirelessly or by wire from one or more EDs or other devices. Although shown combined as a transceiver 1852, a transmitter and a receiver could be separate components. Each antenna 1856 includes any suitable structure for transmitting or receiving wireless or wired signals. While a common antenna 1856 is shown here as being coupled to the transceiver 1852, one or more antennas 1856 could be coupled to the transceiver(s) 1852, allowing separate antennas 1856 to be coupled to the transmitter and the receiver if equipped as separate components. Each memory 1858 includes any suitable volatile or non-volatile storage and retrieval device(s). Each input/output device 1866 facilitates interaction with a user or other devices (network communications) in the network. Each input/output device 1866 includes any suitable structure for providing information to or receiving/providing information from a user, including network interface communications.

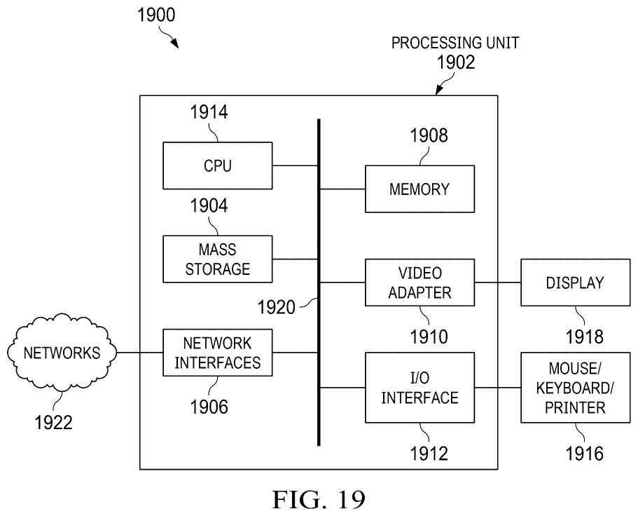

FIG. 19 is a block diagram of a computing system 1900 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1900 includes a processing unit 1902. The processing unit includes a central processing unit (CPU) 1914, memory 1908, and may further include a mass storage device 1904, a video adapter 1910, and an I/O interface 1912 connected to a bus 1920.

The bus 1920 may be one or more of any type of several bus architectures including a memory bus or memory controller, a peripheral bus, or a video bus. The CPU 1914 may include any type of electronic data processor. The memory 1908 may include any type of non-transitory system memory such as static random access memory (SRAM), dynamic random access memory (DRAM), synchronous DRAM (SDRAM), read-only memory (ROM), or a combination thereof. In an embodiment, the memory 1908 may include ROM for use at boot-up, and DRAM for program and data storage for use while executing programs.

The mass storage 1904 may include any type of non-transitory storage device configured to store data, programs, and other information and to make the data, programs, and other information accessible via the bus 1920. The mass storage 1904 may include, for example, one or more of a solid state drive, hard disk drive, a magnetic disk drive, or an optical disk drive.

The video adapter 1910 and the I/O interface 1912 provide interfaces to couple external input and output devices to the processing unit 1902. As illustrated, examples of input and output devices include a display 1918 coupled to the video adapter 1910 and a mouse, keyboard, or printer 1916 coupled to the I/O interface 1912. Other devices may be coupled to the processing unit 1902, and additional or fewer interface cards may be utilized. For example, a serial interface such as Universal Serial Bus (USB) (not shown) may be used to provide an interface for an external device.

The processing unit 1902 also includes one or more network interfaces 1906, which may include wired links, such as an Ethernet cable, or wireless links to access nodes or different networks. The network interfaces 1906 allow the processing unit 1902 to communicate with remote units via the networks. For example, the network interfaces 1906 may provide wireless communication via one or more transmitters/transmit antennas and one or more receivers/receive antennas. In an embodiment, the processing unit 1902 is coupled to a local-area network 1922 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

1. A method performed by a network controller, the method including:
transmitting one or more radio resource control (RRC) messages to a wireless device, wherein the RRC messages comprise configuration parameters indicating one or more resources for a first uplink signal;
receiving, via the one or more resources, the first uplink signal from the wireless device;
deriving a first receive beam based on the first uplink signal;
indicating to the wireless device to receive a first downlink signal based on a transmit beam of the first uplink signal; and
transmitting, to the wireless device, the first downlink signal based on the first receive beam.

2. The method of claim 1, wherein the indicating comprises indicating to the wireless device to receive the first downlink signal based on the transmit beam of the first uplink signal at a first transmission occasion.

3. The method of claim 1, wherein the one or more resources include at least one of:
one or more random access occasions;
one or more sounding reference signal resources; or
one or more physical uplink control channel resources.

4. The method of claim 1, wherein the first uplink signal includes at least one of:
a preamble;
a sounding reference signal, a demodulation reference signal;
a scheduling request;
a physical uplink control channel; or
an uplink control information via physical uplink control channel.

5. The method of claim 1, wherein the first downlink signal includes at least one of:
a physical downlink control channel;
a demodulation reference signal;
a channel state information reference signal; or
a physical downlink data channel.

6. The method of claim 1, wherein the indicating comprises indicating the first receive beam by indicating an index of the first receive beam.

7. The method of claim 6, wherein the index of the first receive beam includes an index of a reference signal.

8. The method of claim 1, further including:
receiving, by the network controller, a second uplink signal, based on the first receive beam and via an analog/hybrid receive panel.

9. The method of claim 8, wherein the second uplink signal is transmitted by the wireless device, based on the transmit beam of the first uplink signal.

10. A method performed by a wireless device, the method comprising:
receiving one or more radio resource control (RRC) messages from a network controller, wherein the one or more RRC messages comprise configuration parameters indicating one or more resources for a first downlink signal;
receiving, from the network controller, the first downlink signal via the one or more resources;
deriving a first receive beam based on the first downlink signal;
indicating to the network controller to receive a first uplink signal based on a transmit beam of the first downlink signal; and
transmitting to the network controller the first uplink signal based on the first receive beam.

11. The method of claim 10, wherein the receiving the first downlink signal comprises receiving the first downlink signal based on a transmit beam of the first uplink signal.

12. The method of claim 10, wherein the indicating comprises indicating to the network controller to receive the first uplink signal based on the transmit beam of the first downlink signal at a first transmission occasion.

13. The method of claim 10, wherein the one or more resources include at least one of:
one or more channel state information reference signal resources, one or more synchronization signal block (SSB) resources, or one or more downlink beam management reference signal resources.

14. The method of claim 10, wherein the first downlink signal includes at least one of:
a channel state information reference signal, a SSB, or a downlink beam management reference signal.

15. The method of claim 10, wherein the first uplink signal includes at least one of:
a physical uplink control channel,
a demodulation reference signal,
a sounding reference signal,
a physical uplink data channel, or
a physical random access channel preamble.

16. The method of claim 10, wherein the indicating comprises indicating the first receive beam by indicating an index of the first receive beam.

17. The method of claim 16, wherein the index of the first receive beam includes an index of a reference signal.

18. The method of claim 10, wherein the RRC messages indicate a plurality of reference signals (RSs), wherein the first downlink signal includes a first one of the plurality of RSs, and wherein the first one of the plurality of RSs is determined according to a reference signal received power (RSRP) of the first one of the plurality of RSs.

19. A network controller, including:
at least one processor; and
a non-transitory computer readable storage medium storing programming, the programming including instructions that, when executed by the at least one processor, cause the network controller to perform:
transmitting one or more radio resource control (RRC) messages to a wireless device, wherein the RRC messages comprise configuration parameters indicating one or more resources for a first uplink signal;
receiving, via the one or more resources, the first uplink signal from the wireless device;
deriving a first receive beam based on the first uplink signal;
indicating to the wireless device to receive a first downlink signal based on a transmit beam of the first uplink signal; and
transmitting, to the wireless device, the first downlink signal based on the first receive beam.

20. The network controller of claim 19, wherein the indicating comprises indicating to the wireless device to receive the first downlink signal based on the transmit beam of the first uplink signal at a first transmission occasion.
